(19) United States
(12) Patent Application Publication
(10) Pub. No.: US 2014/0379801 A1
(43) Pub. Date: Dec. 25, 2014

(54) USER EXPERIENCE ON A SHARED COMPUTING DEVICE

(71) Applicant: QUALCOMM Incorporated, San Diego, CA (US)

(72) Inventor: Binita Gupta, San Diego, CA (US)

(21) Appl. No.: 13/926,808

(22) Filed: Jun. 25, 2013

(51) Int. Cl. H04L 29/08

(52) U.S. Cl. CPC H04L 67/306
USPC 709/204

(57) ABSTRACT

Methods, devices, and systems for utilizing dashboard software that enables retrieval of user account information from various services enjoyed by users of a shared computing device. The dashboard software may be linked to services associated with applications installed on the device. User account credentials (e.g., usernames and passwords) may be stored and used by the dashboard software to retrieve user account information (e.g., messages, notifications, etc.) related to the applications installed on the device. Information may be retrieved directly from applications servers or iteratively via the applications on the device. Dashboard front-ends may be rendered to indicate the retrieved user account information for all users to view on the shared computing device. The dashboard software may also be configured to cause the device to launch applications using stored user account credentials. In an embodiment, a second device may also utilize the dashboard software to obtain account information.

### BACKGROUND

Typically computing devices, like tablets, are shared by multiple family members to access a variety of applications (or “apps”) and data services, including social media sites and email servers. For example, a family tablet computer may be used by a son and daughter to access their respective Facebook® accounts via a Facebook® app, while the parents may check their email accounts using the same device. Many apps and data services may utilize user accounts (or profiles) that are associated with specific individuals such that each user of a shared computing device may have their own user account for a common app. For example, Mom, Dad, and Junior may all have separate Facebook® user accounts used for accessing the Facebook® app on a family tablet. Such applications and data services typically only allow a single user account to be logged-in at a given time, requiring the various users of a shared device to log-in/log-out before and after using the app.

The limitation that all users must log-in/out of apps on a shared computing device creates a suboptimal user experience. Users may dislike having to always log-in to their user accounts, and thus may stop app use over time to avoid the hassle of logging-in/out. Additionally, as only one user account may be active at a given time for an app on a shared computing device, background notifications and data fetch operations may only affect that active account, leaving the other accounts for the app out-of-date. Thus, users must log-in just to determine whether they have received any updates, which can be a frustrating waste of time when no updates or messages have been received. With a single active account, the various users of a shared device may not be well informed of incoming notifications associated with an app, and thus may avoid, forget, or simply not bother to launch that app.

### SUMMARY

The various embodiments provide dashboard software that enables a shared computing device to seamlessly retrieve user account information from various services and/or applications enjoyed by multiple users of the device. The embodiments enable shared computing devices to have concurrent log-ins by multiple users for applications installed on the devices while supporting the single account use structure of most apps and data services. Such capabilities may increase application (and application information) accessibility, and thus result in more app launches/use, more instant gratification, and improved user experience.

The dashboard software may link to various services and/or applications installed on the shared computing device, as well as store user credentials for such services/applications. Periodically, the dashboard software may use the stored credentials to cause the shared computing device to retrieve account information, such as notifications, messages, updates, status changes, etc., from various sources. In an embodiment, the account information may be obtained by the shared computing device logging into locally installed applications associated with services linked to the dashboard software and iteratively accessing account information for all users having a related account. In another embodiment, the account information may be obtained by communications, such as Internet transmissions, with applications servers related to the services linked to the dashboard software for which users of the shared computing device have accounts.

The shared computing device may be configured to render or otherwise display dashboard front-ends that depict information retrieved using the dashboard software. This may enable every user of the shared computing device to see notifications for his/her account (as well as any other user account having stored credentials) without launching any application (or app). In particular, dashboard front-ends may be rendered that indicate the number of notifications, messages, or other account information that is available to users of the shared computing device. For example, a dashboard front-end may include icons for each service linked to the dashboard software, as well as icons for each user having a user account with such services. In an embodiment, the shared computing device may be configured to use the dashboard software to launch applications installed on the device, such as in response to detected user selection inputs corresponding to the dashboard front-end. For example, when a user taps on a dashboard front-end icon that corresponds to a particular user account with a certain service/application (e.g., Facebook®), the shared computing device may be configured to launch the associated application. Further, the shared computing device may be configured to automatically use stored user credentials, such as usernames and passwords, to launch applications without the users having to perform tedious log-in procedures.

In various embodiments, a second device, such as a smartphone mobile computing device or wrist-mounted mobile computing device, may install and utilize the dashboard software. The second device may receive account information (e.g., notifications related to services) as a push service from the shared computing device, such as via short-range wireless signals (e.g., Bluetooth). Alternatively, the second device executing the dashboard software may independently retrieve account information, such as by communicating requests to applications servers. This may enable a user of the second device to monitor the activity/notifications/status of the users of the services associated with the shared computing device, even when not utilizing the shared computing device. In an embodiment, the second device may act as a proxy device by retrieving and relaying account information related to its user to the shared computing device. For example, the shared computing device may be configured to receive and display account information related to a pedometer application installed on the personal smartphones of all the users of the shared computing device. In various embodiments, devices executing dashboard software may be configured to exchange data that indicates the applications installed on such devices. In another embodiment, dashboard software may be configured to link to services associated with applications installed on various devices, such as remote personal devices as well as a shared computing device.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a communication network that includes a mobile computing device linked to local wireless communication networks according to an embodiment.

FIG. 2 is a process flow diagram illustrating an embodiment method for a shared computing device to use dashboard software to retrieve user account information corresponding to applications installed on the shared computing device.

FIGS. 3A-3C are diagrams of embodiment dashboard front-ends that include user account information regarding various users and applications installed on a shared computing device.

FIGS. 4-5 are diagrams of shared computing devices that include embodiment front-ends for dashboard software.

FIG. 6 is a process flow diagram illustrating an embodiment method for a shared computing device to use dashboard software to directly transmit requests to applications servers to retrieve user account information corresponding to services associated with applications installed on the shared computing device.

FIG. 7 is a process flow diagram illustrating an embodiment method for a shared computing device to use dashboard software to log into applications associated with services to transmit requests to applications servers.

FIG. 8 is a process flow diagram illustrating an embodiment method for a shared computing device to use dashboard software to retrieve user account information corresponding to applications installed on the shared computing device and launch the applications.

FIGS. 9A-9B are diagrams showing an embodiment computing device launching an application in response to detecting a user selection input on a dashboard front-end.

FIGS. 10A-B are process flow diagrams illustrating embodiment methods for a shared computing device to use dashboard software to retrieve user account information corresponding to applications relevant to users of the shared computing device.

FIG. 10C is a process flow diagram illustrating an embodiment method for a mobile computing device to use dashboard software to retrieve user account information corresponding to applications relevant to a shared computing device.

FIG. 11A is a diagram of an embodiment shared computing device in communication with a smartphone mobile computing device and a wrist-mounted mobile computing device to distribute user account information for use with dashboard software.

FIG. 11B is a diagram of a shared computing device rendering an embodiment dashboard front-end that includes account information associated with applications installed on the shared computing device and a second device.

FIG. 12 is a process flow diagram illustrating an embodiment method for presenting a user-selectable list used in setting up a dashboard software.

FIG. 13 is a component block diagram of an example tablet computing device suitable for use with the various embodiments.

FIG. 14 is a component block diagram of an example laptop computing device suitable for use with the various aspects.

FIG. 15 is a component block diagram of an example wrist-mounted mobile computing device suitable for use with the various aspects.

FIG. 16 is a component block diagram of a smartphone-style mobile computing device suitable for use in an embodiment.

FIG. 17 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile computing device” or “computing device” are used herein to refer to any one or all of cellular telephones, smart-phones (e.g., iPhone®), web-pads, tablet computers, Internet enabled cellular telephones, WiFi enabled electronic devices, personal data assistants (PDA's), laptop computers, personal computers, and similar electronic devices equipped with at least a processor and a network transceiver configured to establish a wide area network (WAN) or local area network (LAN) connection (e.g., an LTE, 3G or 4G wireless wide area network transceiver, a wired connection to the Internet, or WiFi).

The various embodiments provide methods for executing dashboard software that enables a plurality of users of a shared computing device to be concurrently logged-in to applications installed on the shared computing device and display update notifications for users not actively interacting with an app or data service. The dashboard software may be considered software for providing a multi-platform user interface. The dashboard software may be downloaded or otherwise installed on the shared computing device. For example, the dashboard software may be downloaded from a Google Play® store or iTunes® digital stores for use on family Android® tablets or iPads®, respectively. Once installed on the shared computing device, the dashboard software may be linked to applications also installed on the shared computing device. For example, the dashboard software may be linked to Facebook®, Twitter®, Amazon®, Netflix®, and other common apps that utilize user accounts associated with particular individuals (e.g., family members).

User account credentials, such as user login names and passwords, may be stored in association with the dashboard software. For example, each user of the shared computing device may enter their own username and password manually or alternatively the dashboard software may be configured to scrape data previously stored on the shared computing device (e.g., cookies, configuration files, etc.). With the stored account credentials, the dashboard software executing on the shared computing device may periodically or continually retrieve user account information from each user account for all linked apps on the shared computing device. For example, every second, minute, hour, etc., the dashboard software may retrieve updates, notifications, messages, status changes, and other data for Mom, Dad, and Junior's respective Facebook® accounts for use with a Facebook® app installed on a shared family tablet device. In various embodiments, user accounts handled by the dashboard software may be independent, unrelated, un-nested, unconnected, and otherwise not linked together. For example, the dashboard software may monitor social networking accounts that belong to two parents within a household. In other words, the dashboard software may or may not monitor and manage user accounts that are subaccounts or otherwise utilize parental controls.

In an embodiment, the dashboard software may utilize processes, routines, threads, and/or other services that execute in the background of the shared computing device's operating system, such as background threads maintained by a high-level operating system. This behavior may only be possible on device platforms/operating systems that allow background execution for apps (e.g., Android). Such background processes may directly exchange signals with remote application servers related to the applications linked to the dashboard software. In particular, the dashboard software may utilize various application programming interfaces (APIs) to programmatically login into specified user accounts with such application servers and fetch account data for all users having stored account credentials. For example, the dashboard software executing on the shared computing device may cause a signal to be transmitted to a Facebook® applications server that includes Facebook® API commands for requesting account notification data.

In an embodiment, the dashboard software may be configured to utilize a single networking session to obtain user account information for all users of the shared computing device at once, thereby optimizing network accesses by the shared computing device via the dashboard software. For example, the dashboard software may initiate optimized interactions with a Facebook® application server by retrieving Mom, Dad, and Junior's Facebook® notifications during the same server session.

In another embodiment, the dashboard software may locally access (or login to with stored account credentials) the linked applications and data services in a “round robin” manner in order to fetch new notifications data for each user. In other words, the dashboard software may obtain user account information for an application installed on the shared computing device one user account at a time and store the user account information locally. For example, the dashboard software may interface with an installed Facebook® app executing on the shared computing device, providing the Facebook® app with Dad's stored account credentials related to his Facebook® account, thereby causing the Facebook® app to retrieve Dad's Facebook® account notifications from the Facebook® application server. The dashboard software may then repeat the process using Mom's stored account credentials with the Facebook® app.

Alternatively, instead of downloading updated user account information, the dashboard software may simply determine whether there has been a change or update to a user's account (e.g., a new Facebook® posting or new email), and store/display an indication that an update is available. In this manner, users are quickly informed about their account status (and thus whether there is any benefit to logging-in or launching the app) with a glance at a dashboard front-end display and without downloading/storing (and thus risking compromise) of their user account information.

The dashboard software may be configured to cause the shared computing device to display, render, or otherwise present information and/or graphical elements that represent retrieved user account information. For example, the shared computing device executing the dashboard software may render a dashboard front-end that displays a graphical icon for each individual having stored account credentials for a linked app. Such dashboard front-ends may inform users about the status of the user accounts (e.g., show notifications that new messages are available). In various embodiments, the dashboard software may present graphical elements or icons for each user for each service/application linked to the dashboard software. For example, the dashboard software may cause the shared computing device to display a first icon associated with a first user having a first Facebook® user account and a second icon associated with a second user having a second Facebook® user account. The dashboard software may be configured to display summary or partial information of user account notifications data (e.g., the number of new notifications) for each of the user accounts associated with services/apps linked to the dashboard software. With such displays, all users of the shared computing device will be able to see a list of new notifications (or summary of notifications) for their account, as well as for the other users' accounts. In an embodiment, the dashboard software may also add notifications (or summaries of notifications) to the notification center managed by a high-level operating system (e.g., an Android Notification bar of a shared Android tablet).

In another embodiment, the dashboard software may be configured to launch the linked applications. For example, when a user taps on an app (or update indication) icon on the dashboard front-end displayed on the shared computing device's touchscreen, the dashboard software may launch the app, login to the app using the stored user account credentials, and provide access to the hyperlinked matter (e.g., new postings or email). The dashboard software may or may not be configured to require a security key, password, or other secret information to launch applications.

In various embodiments, to maintain privacy, the dashboard software may display varying degrees of user account information but not permit users to access accounts or account-specific information without providing credentials. For example, the dashboard software may be configured to cause the shared computing device to only display indicators that a user's Facebook® account has a new update (or display the number of new notifications), but not display any of the contents, context, or other details about the update until the user inputs a password. As another example, the dashboard software may cause the shared computing device to render a “new message available” notification for a certain user, but may not launch the linked application/user account without receiving a secret phrase, password, or security key associated with the user (or the account credentials used to launch the application).

In another embodiment, the dashboard software may be configured to be software that is installed and executed on a second computing device. Thus, the dashboard software may be executed by a mobile computing device that is in communication with one or more shared computing devices that may be running the linked applications. For example, Dad may install the dashboard software on his smartphone or wrist-mounted mobile computing device and receive updates about the recent notifications of Mom and Junior's pedometer application accounts that are accessed via a pedometer app executing on the family tablet or laptop. In an embodiment, the dashboard software installed on such a second device may receive notifications/updates corresponding to the applications on the shared computing device via peer-to-peer communications with the shared computing device, or alternatively, as data directly retrieved from applications servers via the Internet. In this way, all users of the shared computing device may utilize the dashboard software on separate devices to receive updates related to the apps on the shared computing device.

In an exemplary use case, doctors may utilize the dashboard software on personal computing devices to monitor the activity of fellow on-call professionals that get recorded on a shared (or common) computing device by those professionals. In another exemplary use case, parents may monitor the online activities of their kids on a shared computing device based on account notifications. In another exemplary use case, dashboard software may be utilized by a mobile computing device to monitor the activity/status of different devices within a place, such as window sensors, garage door sensors, and water heater units within a house. In this way, the dashboard software may provide a consolidated view of the various devices within the place.

In another embodiment, a shared computing device executing the dashboard software may be configured to receive account information from other devices executing dashboard software or apps. For example, personal devices of users associated with the shared computing device may be configured to utilize dashboard software to transmit account information to dashboard software on the shared computing device. In this way, the shared computing device may be used to display account status and other activity information about individual users with devices employing “proxy” dashboard software (or instances of the dashboard software). For illustration, each of a team of “on-call” doctors may employ smartphones executing “proxy” dashboard software. These smartphones may periodically transmit or otherwise provide account information related to applications installed on the smartphones to the shared computing device. The account information of the on-call doctors (e.g., notifications, location reports, activity logs, patient data, etc.) may be transmitted to a shared laptop computing device within an emergency room (ER) that is also utilizing dashboard software and that has stored account credentials for all the on-call doctors.

In various embodiments, dashboard software may be configured to link to services associated with applications installed on various devices. For example, a shared computing device (e.g., a tablet device) executing dashboard software may retrieve account information for user accounts associated with applications installed on a personal device (e.g., a smartphone) executing dashboard software. The shared computing device may use the dashboard software to retrieve account information related to applications installed on the shared computing device, other devices, or both. In other words, dashboard software may be used to provide notifications of account information regardless of whether associated applications are installed on any particular device.

In an embodiment, the dashboard software executing on a shared computing device may be further used to receive local or unpublished account information from a secondary device. For example, the shared computing device may receive via dashboard software social networking updates that have not been uploaded to an applications server by a personal device executing another instance of the dashboard software. Such local updates may be retrieved from personal devices by the shared computing device over peer-to-peer communications.

In an embodiment, a shared computing device may present lists of devices, accounts, applications, and other information to users during a setup procedure for dashboard software. Based on a user's selection of items on such a list, the shared computing device may customize the dashboard software (and related front-end) to link to and display account information from a variety of sources. For example, based on user selections on a touchscreen display, the dashboard software may be configured to link to services associated with social networking applications installed on a daughter's personal device as well as a shared family device.

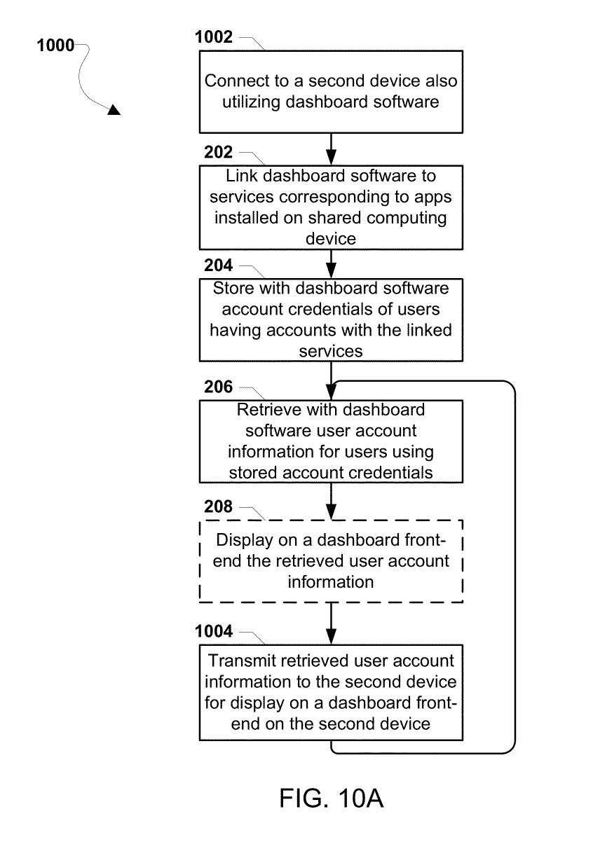

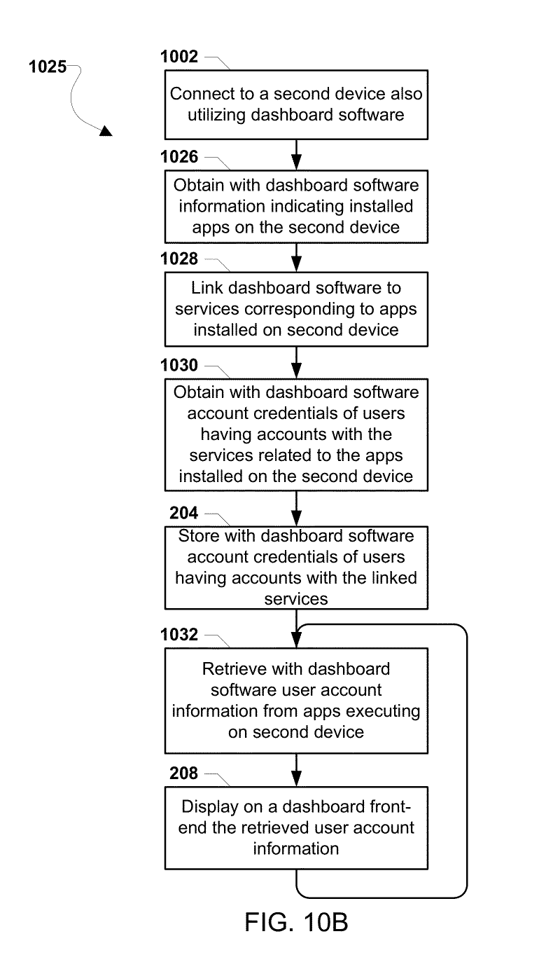

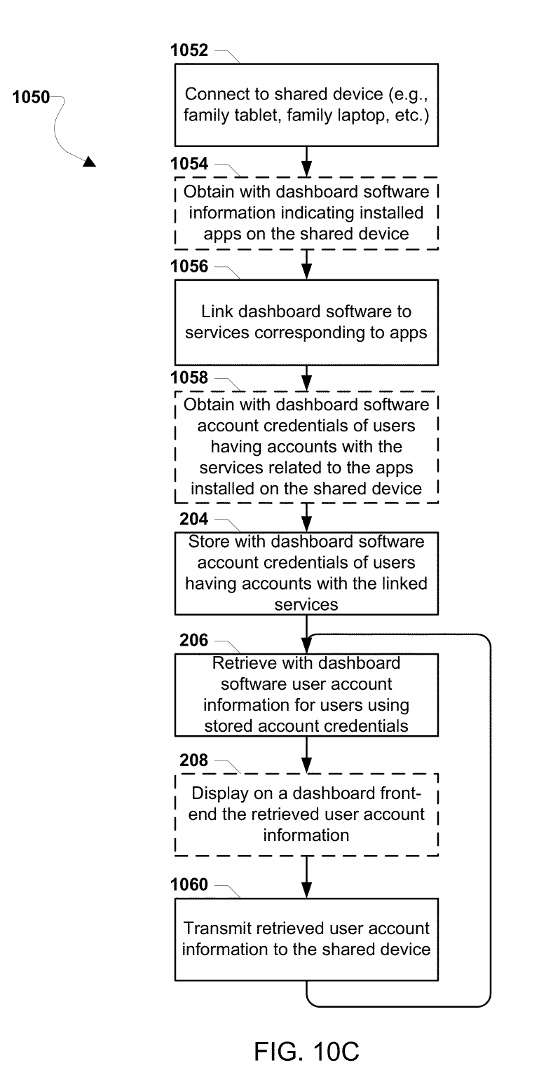

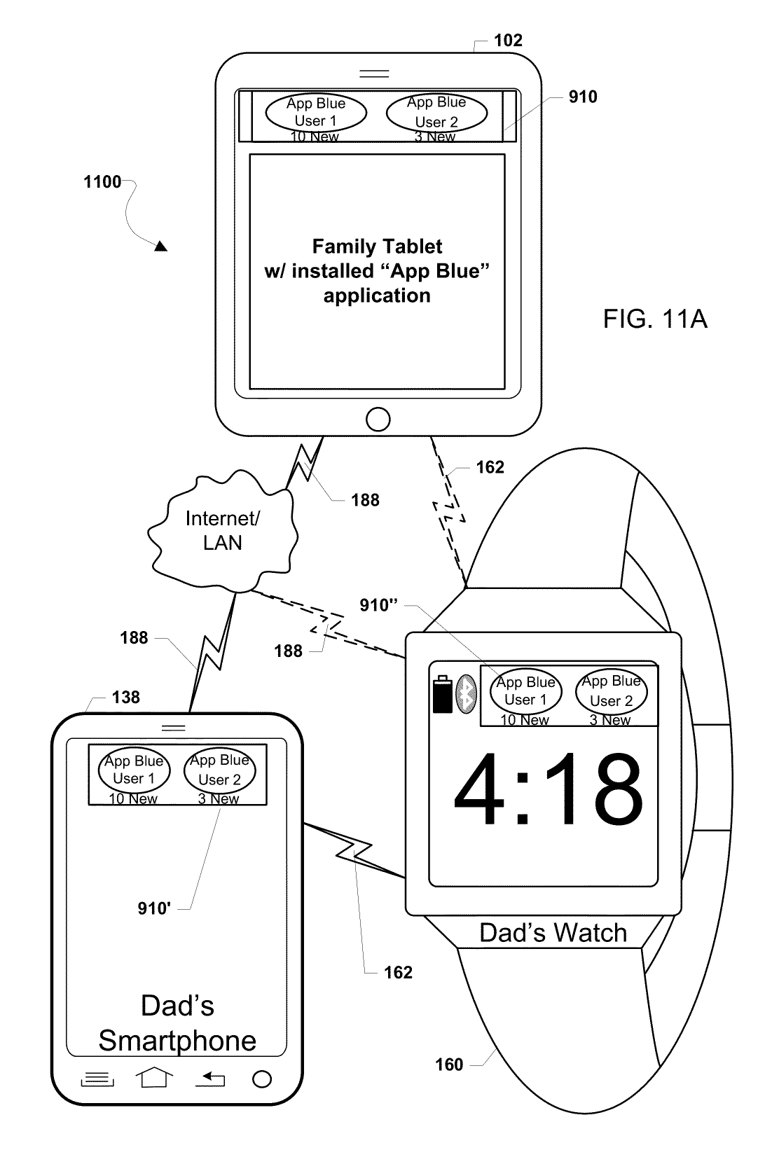

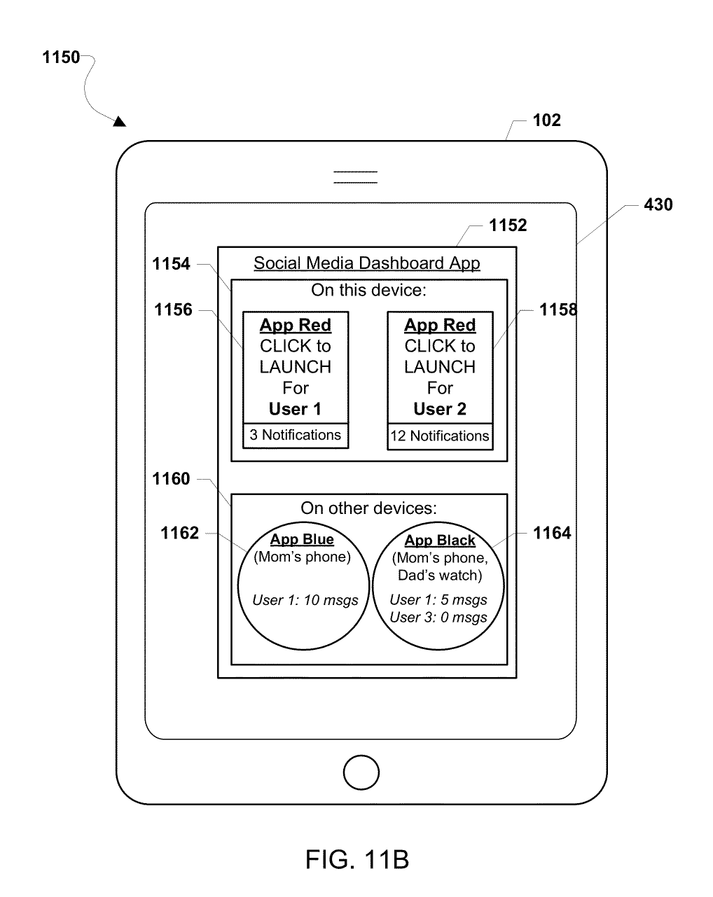

In the following descriptions, the dashboard software may be described as executing on the shared computing device. However, those skilled in the art should appreciate that the dashboard software may be installed and operated on other devices, such as described below with reference to FIGS. 10A-10C, and 11. Also, while the dashboard software enables a shared computing device to provide an interface for multiple users, the dashboard software may provide an interface for a single user, such as if the computing device is not shared.

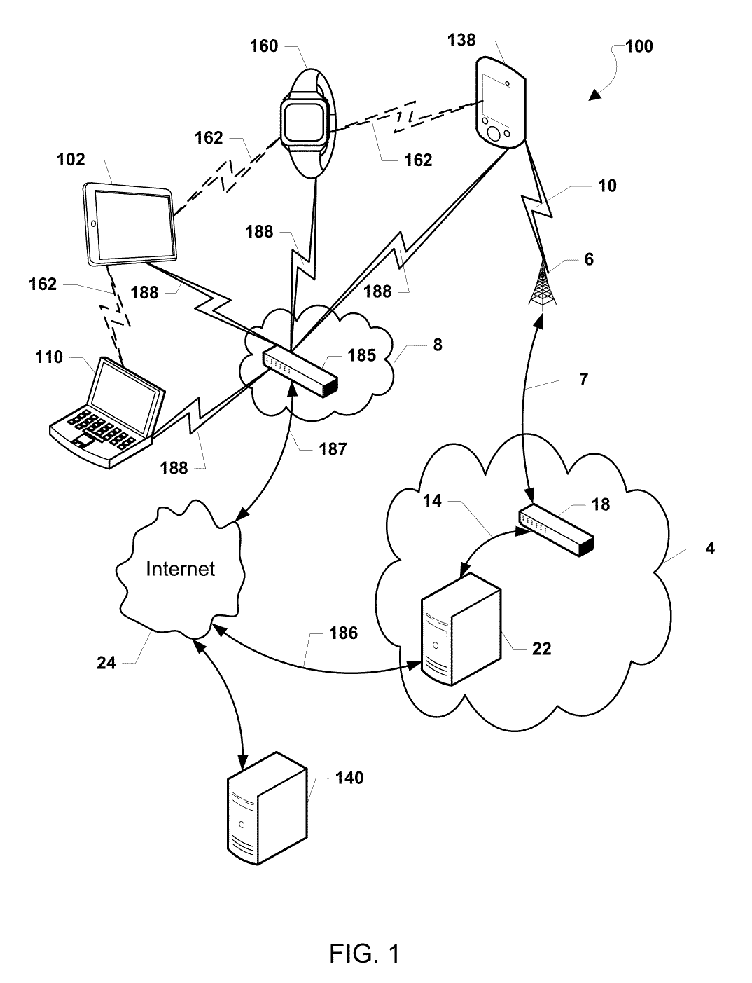

FIG. 1 illustrates a communication network 100 suitable for the various embodiments. In various embodiments, the communication network 100 may include various computing devices, such as a laptop computing device 110, a tablet mobile computing device 102, a wrist-mounted mobile computing device 160, and a smartphone mobile computing device 138. In various embodiments, any or all of these devices may be configured to execute dashboard software as described above. The computing devices 102, 110, 138, 160 may be configured to transmit wireless signals to a wireless router 185 via a wireless data links 188. For example, the computing devices 102, 110, 138, 160 may all be connected to the wireless router 185 within a family home. The computing devices 102, 110, 138, 160 may transmit the wireless signals via the wireless data link 188 by utilizing WiFi transceivers/radios. The wireless router 185 may be associated with a local area network 8 and may provide a connection 187 to the Internet 24, thus enabling the computing devices 102, 110, 138, 160 to communicate with other devices over the Internet 24. For example, the tablet mobile computing device 102 may utilize the wireless data links 188 to exchange data with a remote data source, such as an applications server 140 (e.g., a server associated with services like Facebook®, Twitter®, Expedia®, etc.). In other embodiments, the computing devices 102, 110, 138, 160 may be configured to connect to the Internet 24 via the local area network 8 using wired (not shown) connections.

In an embodiment, the various computing devices 102, 110, 138, 160 may be configured to exchange short-range wireless signals via short-range wireless data links 162. For example, the wrist-mounted mobile computing device 160 and the smartphone mobile computing device 138 may be configured to utilize a Bluetooth, Bluetooth LE, WiFi Direct, RF, Zigbee, Peanut, or other short-range wireless radio/transceiver to exchange signals via the data link 162. In an embodiment, the computing devices 102, 110, 138, 160 may be configured to transmit information for use by dashboard software executing on other computing devices 102, 110, 138, 160, such as information that indicates the presence of installed applications, user account credentials associated with services, and/or notifications data related to user accounts. For example, the tablet mobile computing device 102 may transmit via Bluetooth signals to the wrist-mounted mobile computing device 160 notification data that indicates a user has received a new Facebook® message. In this way, the computing devices 102, 110, 138, 160 may be configured to share data received from the Internet 24 via the data link 188, thereby avoiding unnecessarily expended power and/or other resources.

In an embodiment, the smartphone mobile computing device 138 may be configured to utilize a long-range radio or wireless transceiver to exchange data with a cellular tower 6 via a long-range data link 10. For example, the smartphone mobile computing device 138 may be equipped with a cellular network modem and an antenna capable of transmitting data transmissions to a 3G, 4G or LTE cellular network. In an embodiment, data may be received from the cellular tower 6, such as cell site identification information, general location information, and other data relevant to the cellular network associated with the cellular tower 6. In other embodiments, the other computing devices 120, 160, 110 may also be configured to exchange wireless transmissions with cellular towers 6 via long-range data links (not shown).

In an embodiment, the smartphone mobile computing device 138 may establish communications with a data network 4 via a data link 7 from the cellular tower 6. For example, the smartphone mobile computing device 138 may transmit data through the cellular tower 6 to a cellular telephone system. The data network 4 may include switching centers 18 that are coupled in network connections 14 to Internet gateway servers 22 to enable data connections 186 to the Internet 24. The data network 4 may also enable telephone calls to be made to mobile computing devices, such as smartphones, tablet devices, and feature phones. For example, a smartphone mobile computing device 138 may exchange phone calls and/or SMS text messages with the cellular tower 6 via the long-range data link 10. In an embodiment, the data network 4 may also communicate data, telephone calls, and other information to landline telephones (not shown).

In various embodiments, the computing devices 102, 110, 138, 160 may utilize the data links 10, 188 (e.g., long-range radio data link to a cellular network or local area network 8) to download or otherwise receive data from data sources, such as a web server, a hosting server, or a cloud storage server. For example, an application (or app) executing on the smartphone mobile computing device 138 may initiate a download of data from the applications server 140 via the long-range data link 10. As another example, the laptop computing device 110 executing dashboard software may utilize the wireless data link 188 to receive updates and notifications from the applications server 140 associated with a social networking service (e.g., a Facebook® or Twitter® server). Data sources, such as the applications server 140, may be third-party devices associated with services that provide useful data, such as notifications of social networking accounts, streaming media (e.g., videos, music, podcasts, etc.), emails, and other messaging or information relevant to the users of the computing devices 102, 110, 138, 160.

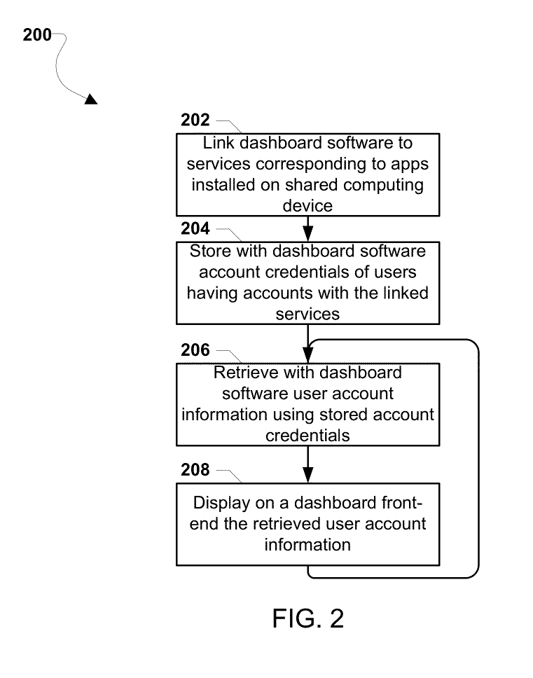

FIG. 2 illustrates an embodiment method 200 for a shared computing device to use dashboard software to retrieve user account information corresponding to applications installed on the shared computing device. As described above, the shared computing device may be a laptop, tablet, or other device that has installed applications, such as a Facebook® or Twitter® app, and that may be shared by a plurality of users. For example, the shared computing device may be a family laptop with an installed Amazon app. Additionally, the dashboard software may be an additional application, app, or other routines that are installed on the shared computing device that retrieve and present indications of the status and/or notifications of user accounts associated with the installed applications. For example, the dashboard software may be a suite of background processes that runs persistently as the shared computing device performs operations related to its other installed applications, such as a Facebook® app.

In block 202, the shared computing device may link the dashboard software to services corresponding to applications (or apps) installed on the shared computing device. In other words, the dashboard software may be provided with information that lists the various applications for which the dashboard software may obtain user account information and otherwise monitor. For example, the shared computing device may be configured to save codes, links, memory addresses, or other operative indicators of applications, application executables, and/or other information representing applications installed on the shared computing device. Such linking may be accomplished by storing pointers or other information within a database or configuration file stored on the shared computing device and accessible by the dashboard software. In block 204, the shared computing device may store with the dashboard software account credentials of users having accounts with the linked services. The shared computing device may store passwords, usernames, aliases, secret words or phrases, and/or any other information needed to access a user account with the linked services. For example, the shared computing device may render a dialog box that requests Facebook® credentials (e.g., usernames and passwords) to be entered by users of the shared computing device and may store such credentials in a datable accessible by the dashboard software. In an embodiment, when the dashboard software is installed and executed, the shared computing device may prompt users to enter all known user account credentials for use by the dashboard software. In other words, the dashboard software may store account credentials for the various users of the shared computing device when those users provide the credentials to the dashboard software.

In block 206, the shared computing device may retrieve with the dashboard software user account information using the stored account credentials. In various embodiments described below, the dashboard software may be configured to retrieve the user account information directly from applications servers and/or via communications exchanged with the applications installed on the shared computing device. For example, the dashboard software may cause the shared computing device to initiate a download of Facebook® account updates and notifications for a particular user using API commands and stored credentials of the user for his/her Facebook® account. In another embodiment, the retrieval of account information by the dashboard software may be accomplished with background processes, threads, and/or routines. In an embodiment, the shared computing device may retrieve account information associated with any and all stored account credentials, such as user account credentials for applications installed on other devices. For example, account information may be retrieved for accounts related to applications installed on the shared computing and/or for accounts related to applications installed on personal devices (e.g., smartphones) connected to the shared computing device.

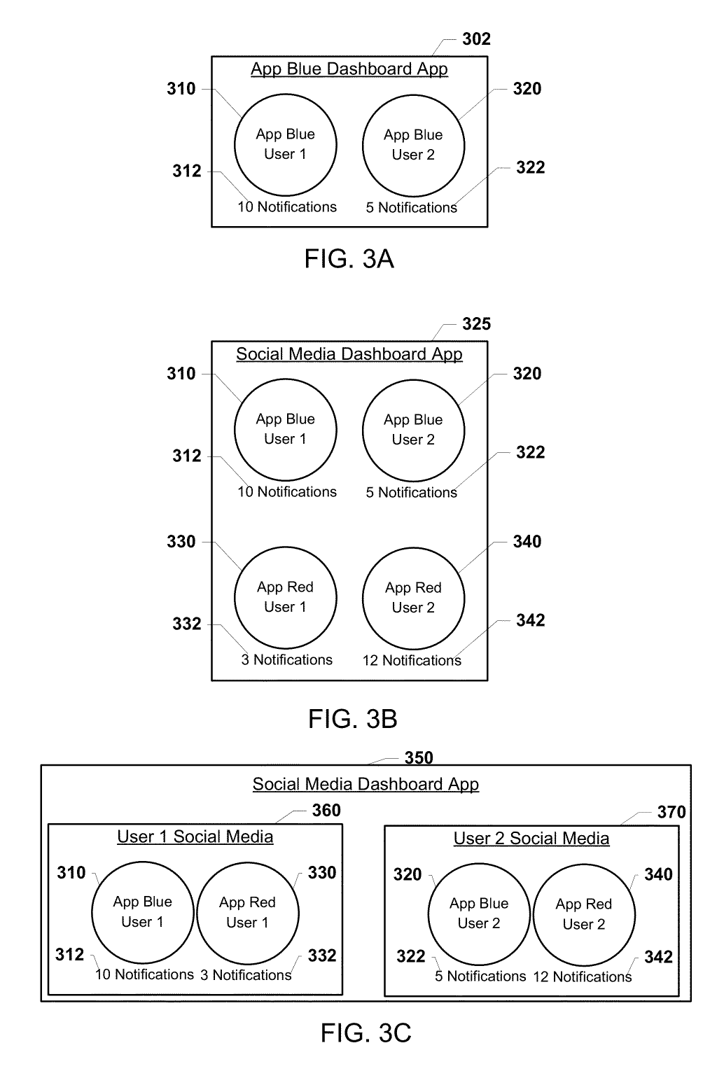

In block 208, the shared computing device may display on a dashboard front-end the retrieved user account information. Examples of embodiment dashboard front-ends are described below with reference to FIGS. 3A-3C. The dashboard front-end may be a graphical user interface for the dashboard software, such as a graphical element that is rendered in the notifications section of a smartphone or other computing device “desktop.” In another embodiment, the dashboard front-end may be a unique section or set of graphics that is displayed as an individual graphical element via a high-level operating system (e.g., a widget), or alternatively, the dashboard front-end may be icons, graphics, or other elements within a pre-existing notification section of the high-level operating system of the shared computing device. For example, the dashboard front-end may be represented in an Android device by notification graphic elements that appear within the notification bar of the Android display. The shared computing device may continue with the operations in block 206. For example, the shared computing device may retrieve new updated account notifications/messages using stored credentials every second, minute, hour, etc. In an embodiment, the dashboard software may be configured to check the linked services for indicators as to whether accounts have changed after previous monitoring by the dashboard software. For example, every several seconds, the dashboard software may cause the shared computing device to transmit a ping message to an applications server to respond with any status changes for a user's Twitter® account.

FIGS. 3A-3C illustrates embodiment front-ends for dashboard software. As described above, a shared computing device executing the dashboard software may retrieve or otherwise obtain user account information for users having stored credentials for linked services, such as services associated with applications installed on a family tablet device. Once such information is retrieved, the shared computing device may display icons or other graphical elements to notify the various users of the retrieved user account information. Accordingly, the dashboard software may control, trigger, maintain, and otherwise cause the shared computing device (or other device executing the dashboard software) to render front-ends (e.g., graphical displays of icons) associated with the dashboard software to visually present the retrieved information of the services associated with applications installed on the shared computing device. In various embodiments, the dashboard software may be customized to render various configurations of the dashboard front-ends. In another embodiment, the dashboard software may be customized for front-ends that represent only the applications for which users have stored account credentials. In various embodiments, shared computing devices may utilize multiple instances of the dashboard software to display customized front-ends displays customized for different apps, groups of apps, or individual users.

FIG. 3A illustrates an embodiment first dashboard front-end 302 that includes user account information regarding only one application installed on a shared computing device. In other words, the first dashboard front-end 302 may present information related to a single linked service (referred to in FIGS. 3A-3C as “App Blue”). The first dashboard front-end 302 may include a graphical icon for each user having stored account credentials for the service. For illustration purposes, the first dashboard front-end 302 may include a first “App Blue” app icon 310 for a first user (referred to in FIGS. 3A-3C as “User 1”) and a second “App Blue” app icon 320 for a second user (referred to in FIGS. 3A-3C as “User 2”). The first dashboard front-end 302 may also render graphics/icons in associated with the first and second “App Blue” app icons 310, 320 that indicate the number of notifications/messages and/or summary of notification related to the respective “App Blue” user accounts. The first dashboard front-end 302 may include a first notification element 312 that indicates that User 1 currently has 10 notifications (or messages, updates, etc.) associated with the “App Blue” app, and may also include a second notification element 322 that indicates that User 2 currently has 5 notifications (or messages, updates, etc.) associated with the “App Blue” app.

FIG. 3B illustrates an embodiment second dashboard front-end 325 displayed on a shared computing device that includes user account information regarding multiple linked services and users having accounts with the services. In other words, the second dashboard front-end 325 may present information related to a first linked service (i.e., “App Blue”) as well as a second linked service (i.e., “App Red”). For example, the second dashboard front-end 325 may represent user account information for multiple apps that are related to social media services (e.g., Facebook®, Twitter®, etc.). The second dashboard front-end 325 may include a graphical icon for each user having stored account credentials for the first and/or second services. For illustration purposes, the second dashboard front-end 325 may include a first “App Blue” app icon 310 for a first user and a second “App Blue” app icon 320 for a second user, as well as a first notification element 312 that indicates that User 1 currently has 10 notifications associated with the “App Blue” app, and a second notification element 322 that indicates that User 2 currently has 5 notifications associated with the “App Blue” app. Additionally, the second dashboard front-end 325 may include a first “App Red” app icon 330 for the first user and a second “App Red” app icon 340 for the second user, as well as a third notification element 332 that indicates that User 1 currently has 3 notifications associated with the “App Red” app, and a fourth notification element 342 that indicates that User 2 currently has 12 notifications associated with the “App Red” app.

FIG. 3C illustrates an embodiment third dashboard front-end 350 displayed on a shared computing device that is organized such that user account information for multiple apps is displayed together. For example, the third dashboard front-end 350 may group and separately render User 1 service notifications for multiple services and User 2 service notifications for multiple services. For illustration purposes, the third dashboard front-end 350 may include a first user group 360 that includes a first “App Blue” app icon 310 for the first user and a first “App Red” app icon 330 for the first user, as well as a first notification element 312 that indicates that User 1 currently has 10 notifications associated with the “App Blue” app, and a second notification element 332 that indicates that User 1 currently has 3 notifications associated with the “App Red” app. The third dashboard front-end 350 may also include a second user group 370 that includes a second “App Blue” app icon 320 for the second user and a second “App Red” app icon 340 for the second user, as well as a third notification element 322 that indicates that User 2 currently has 5 notifications associated with the “App Blue” app, and a fourth notification element 342 that indicates that User 2 currently has 12 notifications associated with the “App Red” app.

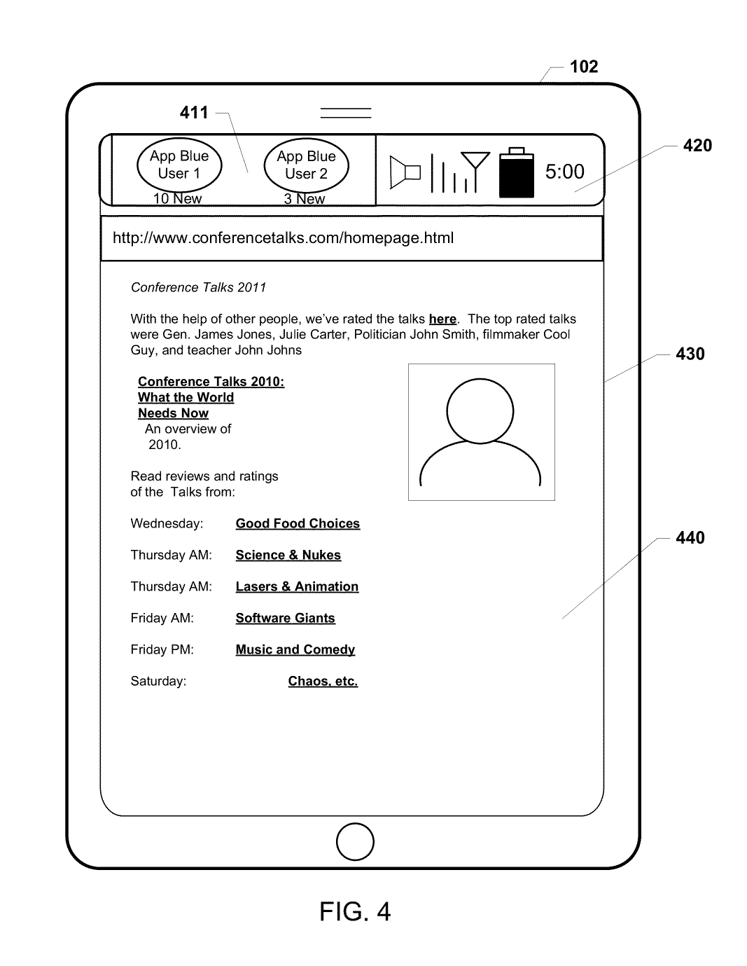

FIG. 4 illustrates a shared computing device 102 that includes an embodiment display of information related to dashboard software. As described above, the shared computing device 102 may be a tablet computing device that is used by the various members of a household, such as a father, mother, and children. The shared computing device 102 may include a display 430, such as an LCD screen having touchscreen capabilities. For example, the display 430 may be used to render a webpage 440 accessed via a browser application executing on the shared computing device 102. Via its high-level operating system, the shared computing device 102 may also render various graphical elements that indicate the status of the shared computing device 102. In particular, the shared computing device 102 may render a notifications bar 420 that includes icons for various capabilities or conditions of the shared computing device 102. For example, the notifications bar 420 may include icons that represent the current state of volume/speaker usage, cellular or WiFi network signal strength, available battery power, and time. The notifications bar may also include a graphical element 411 related to the dashboard software executing on the shared computing device 102. In particular, the graphical element 411 may include summary information that indicates available notifications (or summaries of notifications) and/or account data from user accounts associated with services linked to dashboard software (or dashboard app) executing on the shared computing device 102. For example, the graphical element 411 may include messages that indicate various apps have new messages for particular users of the shared computing device 102. The graphical element 411 may be configured to fit within the notifications bar 420. In another embodiment, the graphical element 411 may be similar to the dashboard front-end for the dashboard software described above with reference to FIGS. 3A-3C. In various embodiments, the shared computing device 102 may be configured to execute various high-level operating systems, such as iOS or Android.

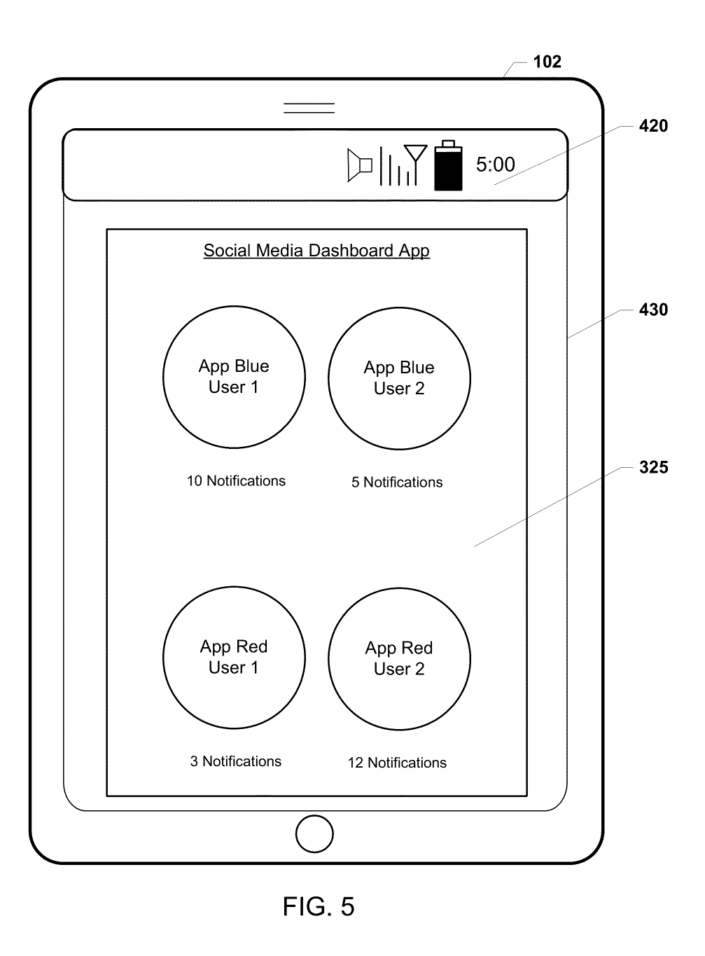

FIG. 5 illustrates a shared computing device 102 that includes an embodiment front-end for dashboard software. As described above with reference to FIG. 4, the shared computing device 102 may include a display 430 and may render a notifications bar 420 that includes icons for various capabilities or conditions of the shared computing device 102. However, unlike in FIG. 4, the shared computing device 102 may be configured to render a dashboard front-end 325 as a stand-alone widget, graphical element, application or other icon set. In particular, the dashboard front-end 325 may be rendered outside of the notifications bar 420. In such a case, the dashboard front-end 325 may be rendered exclusively over other applications. For example, the dashboard front-end 325 may be rendered to display App Red notifications for User 1 at a given time instead of the shared computing device 102 rendering a webpage. In an embodiment, the dashboard front-end 325 may be rendered as a “charm” or an app in the Windows 8® operating system.

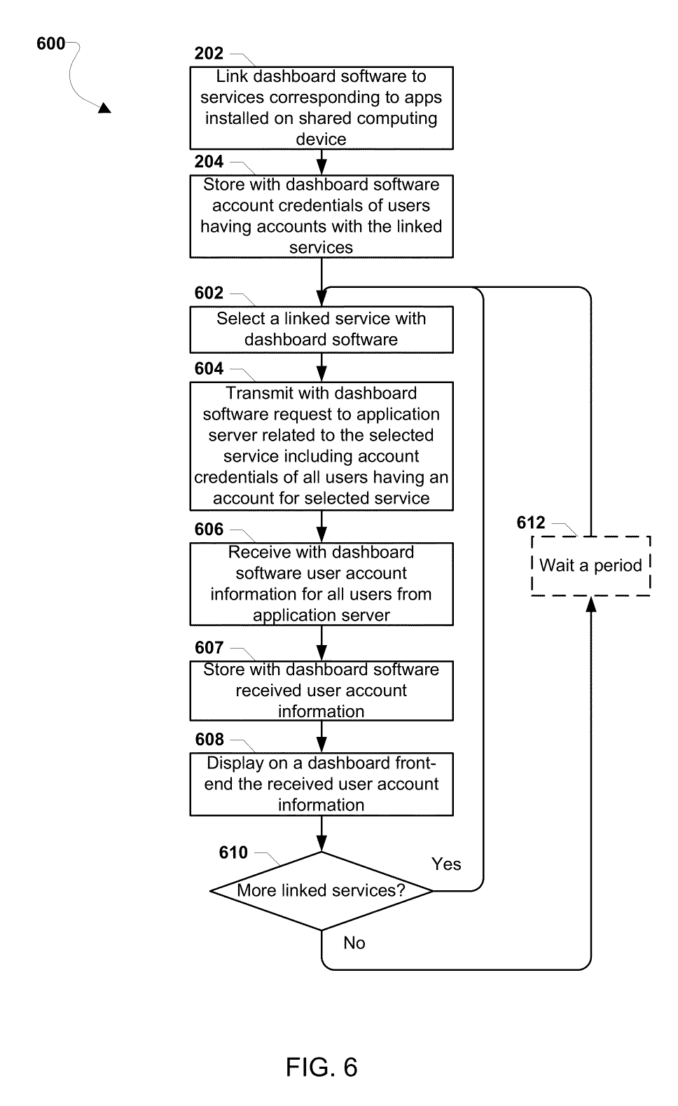

FIG. 6 illustrates an embodiment method 600 for a shared computing device to use dashboard software to directly transmit requests to applications servers to retrieve user account information corresponding to services associated with applications installed on the shared computing device. As described above, the dashboard software may be configured to contact applications servers directly, causing downloads of user data to be received by the shared computing device at once or alternatively in sequence. For example, the dashboard software may cause the shared computing device to transmit a batch request to a Facebook® server that requests account updates for every user in a household that has a Facebook® account. As another example, the shared computing device may initiate a session with the Facebook® server and may transmit a request for user account information for each family member that has a Facebook® account. In various embodiments, the dashboard software may be configured to utilize API libraries, functions, calls, or other commands known to the applications servers to exchange account credentials and user account information. For example, the dashboard software may format transmissions to include function calls specifically designed for communicating with a particular applications server.

In block 202, the shared computing device may link the dashboard software to services corresponding to applications (or apps) installed on the shared computing device. In block 204, the shared computing device may store with the dashboard software account credentials of users having accounts with the linked services. In block 602, the shared computing device may select a linked service with the dashboard software. For example, the dashboard software may be configured to select any service that is linked to the dashboard software with the operations in block 202. In block 604, the shared computing device may transmit with the dashboard software a request to an application server related to the selected service including account credentials of all users having an account for the selected service. In other words, the dashboard software may cause the shared computing device to transmit a request for user account information to the application server related to the selected service. The request may include the passwords, usernames, and other pertinent account credentials needed by the application server to access the user account information of the various users having accounts with the service. In an embodiment, the shared computing device may utilize background processes, operations, routines, or threads to process the request. In an embodiment, the request may be encrypted, obscured, or otherwise encoded to ensure the protection of user credentials. In another embodiment, the request may include other authorization information, such as a pass code or authorization identifier that is known by the application server. For example, the shared computing device using the dashboard software may transmit predefined, authorized keys along with requests to ensure the validity of the request for user account information. In another embodiment, the dashboard software may be configured to cause the shared computing device to transmit requests for each user having stored account credentials for the selected service. For example, within the same server session, the shared computing device may transmit multiple request messages to a Facebook® applications server, one for each family member with a Facebook® account.

In block 606, the shared computing device may receive with the dashboard software user account information for all users from the application server. For example, the user account information may be downloaded as a file that includes the account notifications for all users of the shared computing device that have accounts with the service associated with the applications server. In an embodiment, the shared computing device may decode, parse, or otherwise process the received data in order to access the user account information of the individual users. In block 607, the shared computing device may store with the dashboard software the received user account information. For example, the received information may be stored within a data table, buffer (e.g., a rendering buffer), or other structure accessible to the dashboard software.

In block 608, the shared computing device may display on a dashboard front-end the received user account information. In other words, the shared computing device may render a front-end associated with the dashboard software and display user data for each service linked to the dashboard software as acquired. The shared computing device may display user account information for each linked service, and may be configured to skip displaying information related to services having unavailable (or down) servers. Displaying front-end information is described above with reference to FIGS. 3A-3C, 4, and 5. For example, the dashboard front-end may be rendered by the shared computing device to include icons that indicate a user of a service currently has notifications to view.

In determination block 610, the shared computing device may determine whether there are more linked services, such the services associated with applications installed on the shared computing device that are linked to the dashboard software. In other words, the shared computing device may determine whether the shared computing device has transmitted requests for user account information for all services linked to the dashboard software. If there are more linked services (i.e., determination block 610=“Yes”), the shared computing device may continue with the operations in block 602. If there are no more linked services (i.e., determination block 610=“No”), in optional block 612, the shared computing device may wait a period, such as a number of milliseconds, seconds, minutes, or hours, and then may continue with the operations in block 602. For example, the shared computing device may be configured to request account updates for all services on a periodic basis.

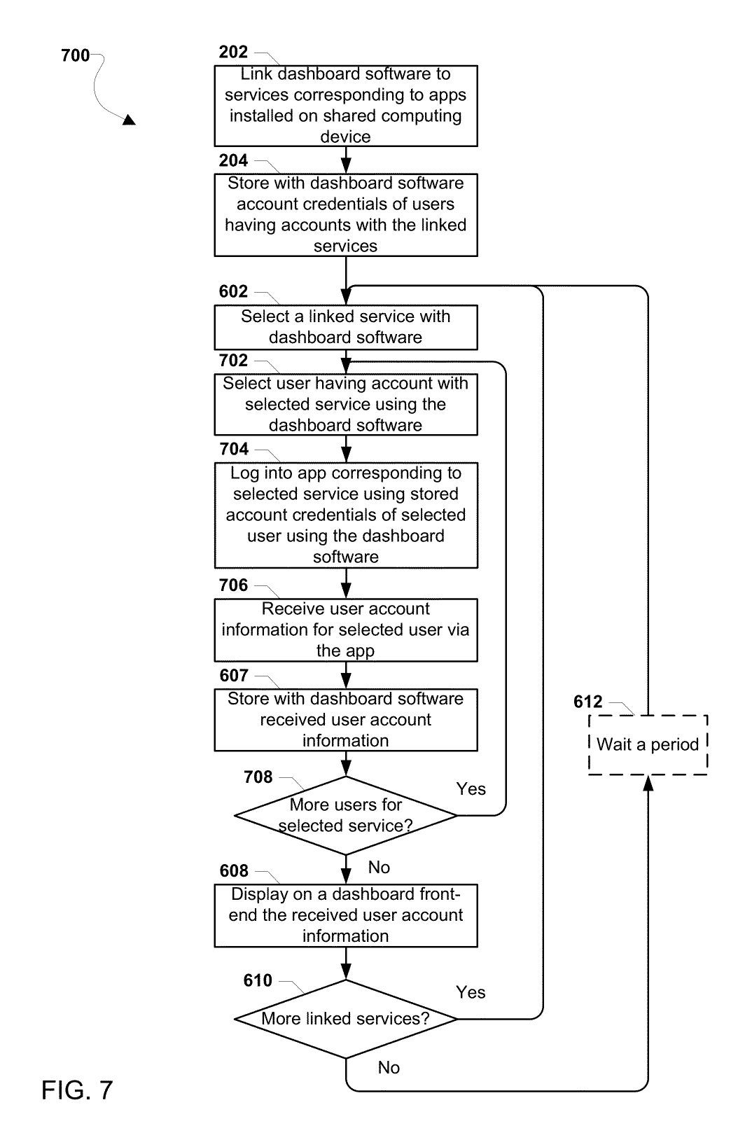

FIG. 7 illustrates an embodiment method 700 for a shared computing device to use dashboard software to log into applications associated with services to transmit requests to applications servers. The method 700 is similar to the method 600 described above, except when performing the method 700 the shared computing device using the dashboard software may not directly transmit requests to an applications server, but instead may cause an application associated with a service to contact the applications server. In this way, the dashboard software may utilize applications installed on the shared computing device to handle request and data exchanges with remote applications servers. However, in doing so, user account information may be retrieved on a user-by-user basis through the applications installed on the shared computing device. In other words, as the dashboard software is used to log into an application with each individual user's stored credentials, only one user's notifications, updates, messages, and other user account information may be retrieved by the application from the applications server at a given time.

In block 202, the shared computing device may link the dashboard software to services corresponding to applications (or apps) installed on the device. In block 204, the shared computing device may store with the dashboard software account credentials of users having accounts with the linked services. In block 602, the shared computing device may select a linked service with the dashboard software. In block 702 the shared computing device may select a user having an account with the selected service using the dashboard software. For example, the shared computing device may select the next user in a list or table of all users of the shared computing device that have an account with the selected service. In this way, the shared computing device with the dashboard software may iteratively address each individual user regarding each linked service (i.e., a “round robin” approach).

In block 704, the shared computing device may log into an application corresponding to the selected service using the stored account credentials of the selected user using the dashboard software. For example, the shared computing device via the dashboard software may provide to the application a command including the username and password of the selected user, and in response, the application may initiate communications with a remote application server using the username and password. The shared computing device may utilize background operations, routines, or threads to perform the log-in operations using the dashboard software and the application. For example, the application may not be invoked or otherwise brought to the foreground of the shared computing device's operations, but instead may be executed as routines running concurrently with other applications, operations, or other duties running on the shared computing device. In an embodiment, the shared computing device may be configured to log into applications installed on other devices via proxy dashboard software running on that devices, such as a Facebook® app installed on a personal mobile computing device connected to the shared computing device via wireless communications (e.g., WiFi or Bluetooth signals).

In an embodiment, the shared computing device may use the selected user or an identifier of the selected user to perform a look-up operation in a database or data table to obtain the stored credentials related to the selected user. In another embodiment, the shared computing device may perform the operations in block 702 by progressing down a list or table that includes users and credentials corresponding to the selected service. For example, the shared computing device may perform a database operation to generate a set of all users and credentials related to the selected service. In block 706, the shared computing device may receive user account information for the selected user via the application. In other words, once logged in with the selected user's credentials, the application executing on the shared computing device may transmit requests to a related applications server for updates, notifications, and other information related to the selected user's account. The application may be configured to cause the shared computing device to deliver any subsequently received user account information from the applications server to the dashboard software.

In block 607, the shared computing device may store with the dashboard software the received user account information. In determination block 708, the dashboard software may determine whether there are any more users for the selected service. In other words, the dashboard software may determine whether user account information has been retrieved for all users of the shared computing device that have user accounts with the selected service. If there are more users for the selected service (i.e., determination block 708=“Yes”), the shared computing device may continue with the operations in block 702. If there are no more users for the selected service (i.e., determination block 708=“No”), the shared computing device may display on a dashboard front-end the received user account information in block 608. For example, user account information may be displayed immediately upon receiving the data from an applications server.

In determination block 610, the shared computing device may determine whether there are more linked services, such the services associated with applications installed on the shared computing device that are linked to the dashboard software. If there are more linked services (i.e., determination block 610=“Yes”), the shared computing device may continue with the operations in block 602. If there are no more linked services (i.e., determination block 610=“No”), in optional block 612, the shared computing device may wait a period, such as a number of milliseconds, seconds, minutes, or hours, and then may continue with the operations in block 602.

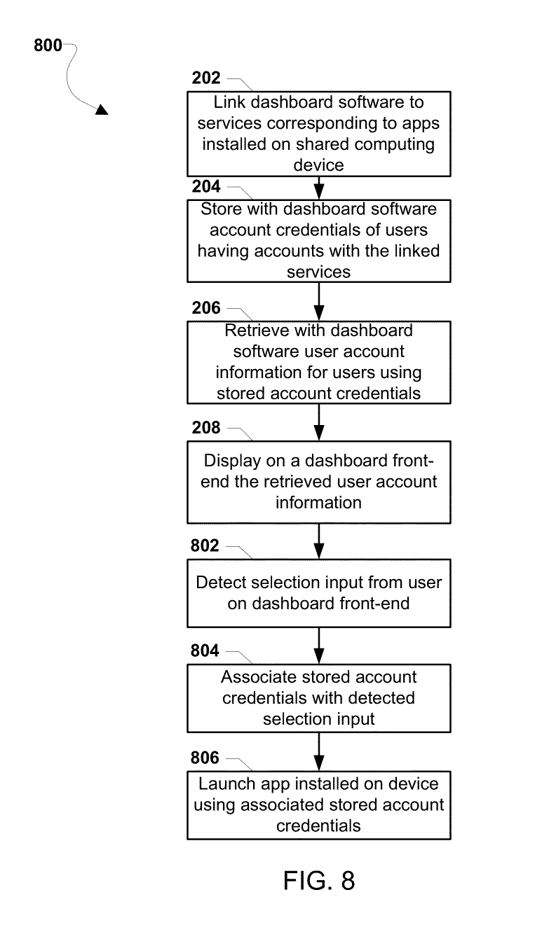

FIG. 8 illustrates an embodiment method 800 for a shared computing device to use dashboard software to retrieve user account information corresponding to applications installed on the shared computing device and launch the applications. As described above, the shared computing device may be a laptop, tablet, or other device that has installed applications, such as a Facebook® or Twitter® app, and that may be shared by a plurality of users, and the shared computing device may be configured to render a dashboard front-end associated with the dashboard software running on the shared computing device. Such a dashboard front-end may be configured to not only display notifications of user accounts associated with the shared computing device, but may also enable the applications associated with the notifications to be launched, loaded, or otherwise activated in a manner that automatically logs a user in and/or out of a service/application. For example, in response to a tap on a dashboard front-end icon related to a User 1's Facebook® notifications, the shared computing device may launch a Facebook® application and log into User 1's account.

In block 202, the shared computing device may link the dashboard software to services corresponding to applications (or apps) installed on the device. In block 204, the shared computing device may store with the dashboard software account credentials of users having accounts with the linked services. In block 206, the shared computing device may retrieve with the dashboard software user account information for users using the stored account credentials. In block 208, the shared computing device may display on a dashboard front-end the retrieved user account information.

In block 802, the shared computing device may detect a selection input from a user on the dashboard front-end. In other words, the shared computing device may monitor for touch inputs, mouse clicks, and other forms of user-provided input on the shared computing device. For example, the shared computing device may detect a touch input on a touchscreen display when the user taps at the display with his finger or a stylus. The shared computing device may determine that the detected selection input coincides or is collocated with the dashboard front-end by comparing coordinates of the selection input (e.g., where the touch input or mouse click occurred relative to the shared computing device display) to the coordinates of the front-end of the dashboard. For example, the shared computing device may determine that a touch input occurred within the graphical display of the dashboard front-end when the touch input occurred within the graphical boundaries of the dashboard front-end.

In block 804, the shared computing device may associate stored account credentials with the detected selection input. The shared computing device may compare the position of the selection input to the dashboard front-end and determine whether the input coincides with icons, graphics, or other display elements associated with a particular user. For example, the shared computing device may determine that a touch input was detected in the same coordinates as an icon within the dashboard front-end that is associated with a first user's Facebook® notifications. The shared computing device may obtain stored credentials for the user and account that corresponds to the selection input, such as by performing a look-up in a stored credential database using the account and/or user name related to the selection input. In block 806, the shared computing device may launch an application installed on the shared computing device using the associated stored account credentials. For example, when the selection input coincides with a front-end graphical element representing the notifications for a User 1 for an “App Blue” app, the shared computing device may launch (or run) the “App Blue” application using the login credentials (e.g., username, password, etc.) for User 1. The operations in block 806 may include logging-out of any currently active accounts. For example, if a first user who is not associated with the associated account credentials is already logged into the application, the dashboard software may cause the shared computing device to log that first user out of the application so that the associated account credentials may be used to log into the application. In an embodiment, in order to increase security or privacy of users, the shared computing device may not fully log a user into the application in response to the selection input, but instead may launch the application and prompt the user for a password, security key, or a keyword associated with the user account corresponding to the selection input. For example, in response to a selection input on the “App Blue” icon for User 1, the shared computing device may launch the App Blue application and prompt the user to provide the security key, phrase, or password for User 1's account.

In an embodiment, the dashboard software executing on the shared computing device may enable users to launch applications installed on the shared computing device only. In other words, regardless of whether the dashboard software is linked to, connected with, or otherwise accessing information from other devices (e.g., personal devices executing proxy dashboard software, etc.), the dashboard software running on the shared computing device may not perform operations to launch an application that is not stored and installed locally on the shared computing device. For example, a user of the shared computing device may only be presented with a “launch” graphical icon associated with an App Blue application when the shared computing device has the App Blue application installed for local execution. However, in such an example, the dashboard software front-end may render notifications of user accounts of the App Blue application regardless of whether it is installed on the shared computing device or another secondary device (e.g., Mom's smartphone running a proxy dashboard software). Launching via the dashboard software is described below with reference to FIG. 11B.

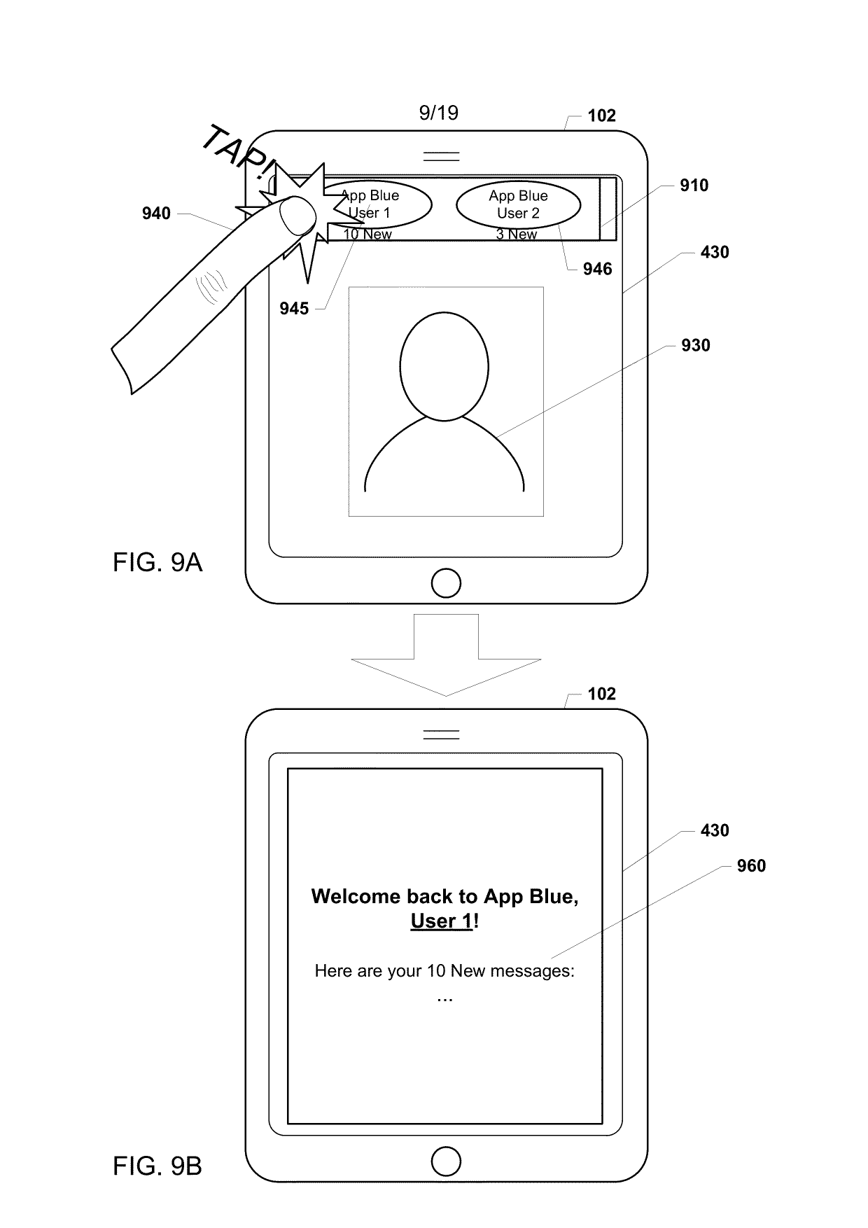

FIGS. 9A-9B illustrate diagrams showing an embodiment computing device 102 launching an application in response to detecting a user selection input on a dashboard front-end. The shared computing device 102 may include a touchscreen display 430, such as a LCD touchscreen configured to render graphical elements (e.g., operating system icons, notifications, browser applications, etc.). For example, the display 430 may be configured to render an image 930, such as a photographic image (e.g., jpg, gif, etc.) embedded within a webpage or set as a background image for the shared computing device operating system desktop environment. The shared computing device 102 may also render a dashboard front-end 910 that includes various graphical elements. For example, the dashboard front-end 910 may include a first graphical element 945 that indicates a “User 1” has new updates/notifications/messages associated with his/her account with an “App Blue” service as well as a second graphical element 946 that indicates a “User 2” has new updates/notifications/messages associated with his/her account with an “App Blue” service.

As described above, the shared computing device 102 may be configured to detect selection inputs from users, as shown with the diagram of FIG. 9A. For example, the shared computing device 102 may detect a tap, swipe, or push by a user finger 940 on the touchscreen display 430. The shared computing device 102 may determine that the selection input occurs within the area of the display 430 coinciding with the dashboard front-end 910. In particular, the selection input may be a tap on the first graphical element 945 that is associated with the User 1's account with the App Blue service.

FIG. 9B illustrates the shared computing device 102 presenting a launched application on the touchscreen display 430. As described above, the shared computing device 102 may associate the selection input with stored credentials for a service (e.g., username and passwords, etc.) and may launch an associated application. For example, the shared computing device 102 using dashboard software may identify that the selection input relates to the User 1 and the App Blue service, and may obtain the username and password for User 1 from stored credentials. With the stored credentials, the shared computing device 102 may be configured to launch the corresponding application, such as the App Blue application installed on the shared computing device 102. The shared computing device 102 with the dashboard software may also be configured to use the credentials to log into the launched application. The launched application may be rendered on the display 430 such that it presents a welcome screen 960 to the user corresponding to the first graphical element that was tapped as shown in FIG. 9A. In other words, the screen 960 may indicate that User 1 is logged in to the application.

FIG. 10A illustrates an embodiment method 1000 for a shared computing device to use dashboard software to retrieve user account information corresponding to applications installed on the shared computing device and transmit the information to a second device. In various scenarios, individuals may desire to receive updated user account information related to the users of the shared computing device, even when the individuals are not using the shared computing device. For example, a Mom may want to receive updates of the online activity associated with her children's massively multiplayer online video games, Facebook®, Twitter®, etc. . . . . As another example, a doctor or other professional “on call” may need to receive up-to-date indicators of the notifications being sent or received by other professionals (e.g., pages, emergency calls, etc.). Thus, it may be important to configure the shared computing device to push retrieved user account information to other devices.

In block 1002, the shared computing device may connect to a second device that is also utilizing dashboard software. In other words, the dashboard software of the shared computing device (e.g., a first dashboard software) may connect with dashboard software executing on the second device (e.g., a second dashboard software). The second device may be any computing device used by a user of the shared computing device, such as a wrist-mounted mobile computing device, a smartphone, or other mobile computing device. In various embodiments, the connection to the second device may be wired or wireless and may be via a peer-to-peer (P2P) connection or protocol, a WAN connection (e.g., WiFi, etc.), short-range wireless signals (e.g., Bluetooth, Zigbee, RF, etc.), or other communication path that utilizes the Internet or a local area network. In other words, the dashboard software of both devices may communicate via a peer-to-peer connection, a WAN connection, etc. For example, the shared computing device and the second device may be configured to exchange data via a secure communication tunnel over the Internet, or alternatively via a Bluetooth paired connection. In an embodiment, the connection to the second device may or may not be persistent.

In block 202, the shared computing device may link the dashboard software to services corresponding to applications (or apps) installed on the shared computing device. In block 204, the shared computing device may store with the dashboard software account credentials of users having accounts with the linked services. In block 206, the shared computing device may retrieve with the dashboard software user account information for users using the stored account credentials. In optional block 208, the shared computing device may display on a dashboard front-end the retrieved user account information. The operations in block 208 may be optional as, in an embodiment, the second device may be configured to be the only device to monitor and display user account information notifications. For example, the dashboard software executing on the shared computing device may be configured to perform operations as background routines or processes only, without indicating to users of the shared computing device that user account information is periodically retrieved (i.e., a “stealth” mode). In block 1004, the shared computing device may transmit retrieved user account information to the second device for display on a dashboard front-end on the second device. For example, the shared computing device may transmit to the second device a wireless signal via Bluetooth protocols that includes notifications information related to a user account (e.g., updated account information). In various embodiments, the transmitted user account information may also include user account credentials (e.g., passwords), and may or may not be encrypted, encoded, or otherwise obscured. The shared computing device may then continue with the operations in block 206.

FIG. 10B illustrates an embodiment method 1025 for a shared computing device to use dashboard software to obtain user account information corresponding to applications installed on other devices also using the dashboard software. In various scenarios, a group of people, such as a family or a team of professionals (e.g., doctors on call), may desire to have a central device that can report current information related to the various individuals based on their individual accounts. For example, a team of doctors on call may benefit from a centrally-located shared computing device (e.g., an ER terminal, a nurse's station laptop, etc.) that is configured to show the latest status information of the various team members based on account information associated with apps executing on personal devices carried by each doctor (e.g., smartphone, wrist-mounted computing device, etc.). To accomplish this, the dashboard software may be installed and executing on both the shared computing device and the personal devices. In other words, “proxy” dashboard software (or apps) may be executing on personal devices that are in communication with the dashboard app running on the shared computing device and may be configured to provide the same view of account information to the users of the personal devices and the shared computing device. In various embodiments, dashboard software (or dashboard software instances) installed on such personal devices may be configured to retrieve account information from applications servers (e.g., a pedometer app data server, etc.), thus enabling the dashboard software executing on the shared computing device to receive account information of users through their personal devices. In this way, the shared computing device may be configured to receive and display user account information retrieved by the other devices without having to support innumerable installed apps.

In block 1002, the shared computing device may connect to a second device that is also utilizing dashboard software. As described above, the second device may be a personal device of a user of the shared computing device, such as a doctor's wrist-mounted mobile computing device that supports a wireless peer-to-peer (P2P) connection with the shared computing device stored within an emergency room. In block 1026, the shared computing device may obtain with the dashboard software information indicating the installed apps on the second device. In other words, the shared computing device may cause the second device to expose a list of applications, software, routines, and other operations installed and/or running on the second device. For example, the dashboard software may exchange messages with software (e.g., a proxy dashboard software instance, etc.) executing on the second device and receive a data structure that includes identifiers of all social networking apps installed on the second device. In block 1028, the shared computing device may link the dashboard software to services corresponding to applications (or apps) installed on the second device. The operations of block 1028 may be similar to those in block 202, except that the shared computing device may associated its dashboard software with the second device's apps instead of locally executed apps. In another embodiment, the shared computing device may link the dashboard software to applications that are installed only on the second device, that are installed on both the shared computing device and the second device, and/or applications that are only installed on the shared computing device.

In block 1030, the shared computing device may obtain with the dashboard software account credentials of users having accounts with the services related to the apps installed on the second device. For example, the shared computing device may utilize a peer-to-peer connection with the second device to request and receive usernames, passwords, and other data needed to log-into user accounts associated with the applications installed on the second device.

In block 204, the shared computing device may store with the dashboard software account credentials of users having accounts with the linked services. In various embodiments, the shared computing device may store credentials individually provided by all users of the shared computing device. For example, all doctors on call during a certain shift may be required to sign-in to the dashboard software on the shared computing device to enable the shared computing device to access the services and/or applications executing on the doctors' personal devices. In another embodiment, the stored credentials may be passwords, secret keys, usernames, and other information that is used only by the dashboard software. For example, instead of storing the usernames and passwords of individual social networking accounts for various users of the shared computing device, the shared computing device may only store a dashboard username and password to enable the communication and exchange of data between various instances of the dashboard software running on personal and shared devices.

In block 1032, the shared computing device may retrieve with the dashboard software user account information from applications executing on the second device. As described above, the shared computing device may retrieve the information in various ways, including directly accessing applications servers using the stored account credentials, requesting/receiving updated account information from apps installed on the second device using the account credentials (e.g., logging into the apps on the personal devices), and/or merely requesting an exchange of account information from an instance of the dashboard software executing on the personal devices (e.g., via P2P communications). In other words, the shared computing device may be configured to transmit account information requests relevant to any and all apps running on the personal devices of users of the shared computing device without having to indicate individual apps and/or account credentials. For example, the shared computing device may use the dashboard software to transmit a request to a doctor's personal smartphone running an instance of the dashboard software to use any available credentials stored on the smartphone to retrieve and relay account status information for all social networking applications installed on the smartphone. In another embodiment, the shared computing device may retrieve account information associated with any/all stored account credentials. For example, account information may be retrieved for applications installed on the shared computing device and/or the second device.

In block 208, the shared computing device may display on a dashboard front-end the retrieved user account information, and may continue with the operations in block 1032. For illustration purposes, a shared tablet computing device used by a family may perform the method 1025 with dashboard software to collect and display account information associated with a pedometer app executing on Junior's, Mom's, and Dad's smartphones that are also executing dashboard software. In particular, the family tablet computer may use the dashboard software to retrieve and display the number of steps each family member has taken within the last hour. In such an illustration, the family tablet computer may or may not also be configured to execute the pedometer app. As another illustration, the shared computing device may be an ER laptop that uses the dashboard software to link to an “on call” application executing on the smartphones used by all ER doctors. Such an ER laptop may utilize the dashboard software with stored account credentials to receive and display the current working status of all on-call doctors by receiving account information from the “on call” applications from the various ER doctors' smartphones. In such a case, only the shared ER laptop may store the account credentials for all doctors (e.g., the ER laptop may store senior doctor account credentials, but each doctor's smartphone may only store the individual account credentials for that doctor).

In an embodiment, the shared computing device (or any device configured to execute dashboard software) may perform any combination of the operations of the method 1000 and/or method 1025. In particular, the shared computing device may perform operations to link to services associated with both the applications installed on the shared computing device and applications installed on other (i.e., second) devices. For example, the shared computing device may be configured to retrieve account notifications for a first user account associated with an App Blue installed on a connected second device as well as account notifications for a second user account associated with an App Red installed on the shared computing device. Further, the shared computing device may be configured to retrieve user account information for various linked services/applications in any of the manners described above. For example, the shared computing device may directly contact an applications server to retrieve account information related to a first app installed on a second device and may log-into a second app installed on the shared computing device to retrieve account information for another user account.

In an embodiment, the shared computing device may use the dashboard software to retrieve account information that is locally stored on the second device, and vice versa. In other words, the shared computing device may use the dashboard software to receive and render in-progress, draft, or otherwise unpublished account information associated with services of installed applications on the second device. For example, the dashboard software running on the shared computing device may retrieve information that indicates that the connected second device has locally stored a Twitter tweet that has not yet been transmitted (or submitted) to the Twitter applications server. In this way, local updates related to user accounts may be communicated and shared between dashboard software executing on the shared computing device and/or the second device even if there were connectivity issues with the application server.

FIG. 10C illustrates an embodiment method 1050 for a mobile computing device to use dashboard software to retrieve user account information corresponding to applications relevant to a shared computing device. The method 1050 is similar to the method 1000 described above, except that the method 1050 may be performed by a mobile computing device that is not a shared computing device and that may or may not have common applications installed. In other words, the mobile computing device may execute dashboard software to retrieve and/or relay user account information related to the users of the shared computing device. This method 1050 may be used when a parent, professional, or other individual wants to use their personal mobile computing device (e.g., smartphone, wrist-mounted device, etc.) to monitor the activities of accounts accessed via the shared computing device. For example, a Dad may use his wrist-mounted mobile computing device executing dashboard software to retrieve pedometer app notifications for his kids who access their pedometer accounts on a family tablet device. Alternatively, the method 1050 may be performed by a mobile computing device executing dashboard software that is configured to act as proxy software for delivering account information to the shared computing device. For example, a smartphone mobile computing device may perform the method 1050 as a background routine/operation/process to supply a shared computing device with account information via a peer-to-peer connection.

In block 1052, the mobile computing device may connect to a shared device, such as a family tablet or family laptop. In various embodiments, the connection to the shared computing device may be wired or wireless and may be via peer-to-peer (P2P) protocols, short-range wireless signals (e.g., Bluetooth, Zigbee, RF, etc.), or other communication path that utilizes the Internet or a local area network. In another embodiment, the mobile computing device may not connect to the shared computing device, but instead may receive information about the shared computing device from a central server accessible over the Internet, such as a data server that maintains operational data or other configuration information regarding the shared computing device (e.g., a data warehouse). For example, a cloud server may store information about the shared computing device, such as the applications currently installed. In various embodiments, the connection to the shared computing device may or may not be persistent.

In optional block 1054, the mobile computing device may obtain with dashboard software information indicating installed applications (or apps) on the shared device. The mobile computing device may obtain this information using various manners, such as requesting/receiving the information directly from the shared computing device (e.g., via P2P, Bluetooth links, etc.), or alternatively from a data server as described above. For example, the mobile computing device may utilize a wireless link to the shared computing device (e.g., Bluetooth) to receive configuration or registry data that indicates a Facebook® app and a Twitter® app are currently installed on a family laptop computing device. In an embodiment, the obtained information may be a list of applications installed on the shared computing device. In block 1056, the mobile computing device may link the dashboard software to services corresponding to applications (or apps), such as apps installed on the mobile computing device and/or those indicated to be installed on the shared computing device. For example, the mobile computing device may link the dashboard software to applications that are installed only on the mobile computing device, that are installed on both the shared computing device and the mobile computing device, and/or applications that are only installed on the shared computing device.

In optional block 1058, the mobile computing device may obtain with the dashboard software account credentials of users having accounts with the services related to the apps installed on the shared device. The mobile computing device may obtain this information in a similar manner as the information regarding the installed applications on the shared computing device. For example, the mobile computing device may exchange communications with a cloud server that maintains data that indicates the users accounts associated with the shared computing device. In various embodiments, the mobile computing device may use authorization passwords, keys, or other indicators when obtaining such information from the shared computing device or a remote data server. For example, in order to obtain information indicating the apps installed on the shared computing device, the mobile computing device may first need to execute a bonding or authorization routine in which the shared computing device authorizes, provides access, and otherwise confirms that the mobile computing device is permitted to receive such information. The operations in optional blocks 1054 and 1058 may be performed when the mobile computing device is configured to retrieve account information related to applications installed on the shared computing device. However, these operations may not be performed when the mobile computing device is configured to retrieve account information related to applications installed on the mobile computing device.

In block 204, the mobile computing device may store with the dashboard software the account credentials of the users having accounts with the linked services. Such account credentials may be obtained from the shared computing device, as described above with reference to optional block 1058, or alternatively as obtained from the user of the mobile computing device. For example, the user of a smartphone mobile computing device may manually enter a username and password into a dashboard software app or an app linked to the dashboard software (e.g., a Facebook® app). In block 206, the mobile computing device may retrieve with the dashboard software user account information for users using the stored account credentials, such as by directly transmitting messages to applications servers. In other embodiments, the mobile computing device executing the dashboard software may log into apps installed on the mobile computing device or alternatively transmit messages to the shared computing device that instruct the applications installed on the shared computing device to log-in to accounts and retrieve user account information in a round-robin manner, as described above. In optional block 208, the mobile computing device may display on a dashboard front-end the retrieved user account information. In an embodiment, the mobile computing device may be configured to perform the dashboard software as proxy software or background operations that merely relay account information to the shared computing device without displaying that information to the user of the mobile computing device.

In block 1060, the mobile computing device may transmit the retrieved user account information to the shared computing device. In such a case, the shared computing device may avoid expending time and power to individually retrieve the user account information that has already been obtained by the mobile computing device. The mobile computing device may then continue with the operations in block 206.

FIG. 11A illustrates a diagram 1100 of an embodiment shared computing device 102 in communication with a smartphone mobile computing device 138 and a wrist-mounted mobile computing device 160 to distribute user account information for use with dashboard software. As described above, the shared computing device 102, such as a tablet used by a plurality of members of a family, may be configured to execute dashboard software and display a dashboard front-end 910. For illustration, the shared computing device 102 may have installed an “App Blue” application that is used by at least two users, a “User 1” (e.g., Mom) and a “User 2” (e.g., Daughter). The dashboard front-end 910 may thus display graphical elements indicating the new messages/notifications/updates for both User 1 and User 2. In various embodiments, the shared computing device 102 may be connected to the Internet or a local area network (“LAN”) via wireless data link 188.

Additionally, the shared computing device 102 may be wirelessly connected to the wrist-mounted mobile computing device 160 via a data link 162. For example the shared computing device 102 may be connected to the wrist-mounted mobile computing device 160 via a Bluetooth connection (e.g., a paired connection). The wrist-mounted mobile computing device 160 may be a personal device of a particular individual (e.g., Dad's watch). The wrist-mounted mobile computing device 160 may also execute dashboard software and therefore may display a dashboard front-end 910″ that indicates user account information, notifications, updates, etc. related to the App Blue application installed on the shared computing device 102. In another embodiment, the wrist-mounted mobile computing device 160 may utilize a data link 188 to obtain user account information for use by the dashboard software, such as by requesting the user account information from the shared computing device 102 over the local area network or alternatively from a remote server (e.g., a cloud server), as described above. In an embodiment, the wrist-mounted mobile computing device 160 may be the second device described above with reference to FIG. 10A or alternatively may be the mobile computing device described above with reference to FIG. 10C. In other words, the wrist-mounted mobile computing device 160 may be configured to directly retrieve account information from an applications server (not shown) or alternatively receive that information from the shared computing device 102 via the data link 188 (e.g., a P2P connection).

In another embodiment, the smartphone mobile computing device 148 may also execute dashboard software and therefore may render a dashboard front-end 910′ that indicates user account information, notifications, updates, etc. related to the App Blue application installed on the shared computing device 102. The smartphone mobile computing device 138 may be a personal device of a particular individual (e.g., Dad's smartphone). The smartphone mobile computing device 138 may also utilize a data link 188 to obtain user account information for use by the dashboard software, such as by requesting the user account information from the shared computing device 102 over the local area network or alternatively from a remote server. Additionally, the smartphone mobile computing device 138 and the wrist-mounted mobile computing device 160 may be connected via a wireless data link 162 and may exchanged data for use by the dashboard software. For example, the smartphone mobile computing device 138 may be configured to obtain user account information that indicates the current notifications for User 1 and User 2 with regards to App Blue application on the shared computing device, and may transmit that user account information via the data link 162 to the wrist-mounted mobile computing device 160 for display via its dashboard front-end 910″. In another embodiment, the smartphone mobile computing device 138 may be configured to obtain user account information for use with the dashboard software via a cellular network connection (not shown), such as by using a cellular transceiver to request data from a cloud server or the shared computing device 102 via the Internet. In an embodiment, the smartphone mobile computing device 138 may be the second device described above with reference to FIG. 10A or alternatively may be the mobile computing device described above with reference to FIG. 10C.

As described above with reference to FIG. 10B, in various embodiments the shared computing device 102 may be configured to receive account information from the mobile computing devices 138, 160. For example, via the dashboard software, the shared computing device 102 may receive account information related to applications installed only on the wrist-mounted mobile computing device 160 (e.g., pedometer account information indicating Dad's recent walking activity). Further, the shared computing device 102 may receive account information from the wrist-mounted mobile computing device 160 via the short-range data link 162 (e.g., Bluetooth) or any other peer-to-peer connection.

FIG. 11B illustrates a display 1150 of a shared computing device 102 rendering an embodiment dashboard front-end 1152 that includes account information associated with applications installed on the shared computing device 102 and another connected device. As described above, the shared computing device 102 executing dashboard software may be configured to retrieve and render account information for user accounts associated with applications installed on the shared computing device 102, applications installed on a connected device (e.g., a wrist-mounted personal device executing dashboard software, etc.), applications installed on both, or any combination thereof. For illustration purposes, the dashboard front-end 1152 may include a first group 1154 related to applications installed on the shared computing device 102. In particular, the first group 1154 may include graphical icons 1156, 1158 representing account information related to an “App Red” application installed on the shared computing device 102. In the illustrated example, the first icon 1156 indicates that a User 1 has 3 notifications for the App Red application, and the second icon 1158 indicates that a User 2 has 12 notifications for the App Red application. The icons 1156, 1158 may be configured to operate as virtual buttons that, when touched, tapped, or otherwise interfaced with by a user may cause the shared computing device 102 to launch the installed “App Red” application. For example, when a user presses the first icon 1156 on the touchscreen display 430, the shared computing device 102 may utilize the dashboard software to launch the App Red application with the account credentials associated with User 1.

The dashboard front-end 1152 may also include a second group 1160 of icons related to applications that are not installed on the shared computing device 102 (i.e., applications installed on “other” devices). The second group 1160 of icons may represent account information (e.g., notifications, message indicators, etc.) associated with user accounts that are accessed on other devices connected to the shared computing device 102. In the illustrated example, the second group 1160 of icons may include a first graphical icon 1162 that corresponds to an “App Blue” application that is installed on a “Mom's phone” and that indicates a User 1 has 10 messages. Also in the illustrated example, the second group 1160 of icons may also include a second graphical icon 1164 that corresponds to an “App Black” application that is installed on “Mom's phone” and “dad's watch” device and that further indicates “User 1” has 5 messages and “User 3” has no messages. The icons 1162, 1164 may be configured to be non-interactive so that the user of the shared computing device 102 may only see the account information, but may not be allowed to launch any software using the icons 1162, 1164.

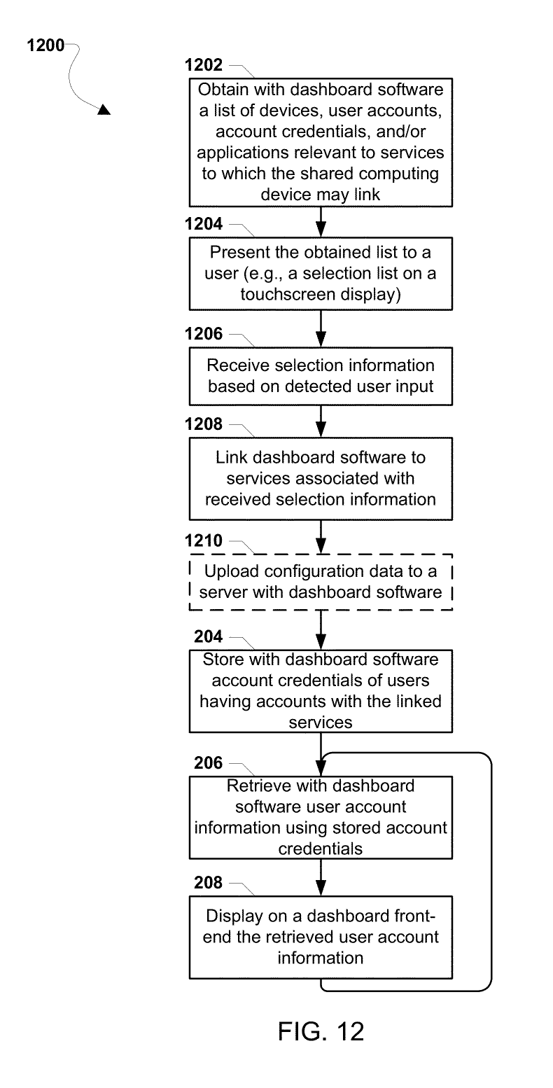

FIG. 12 illustrates an embodiment method 1200 for presenting a user-selectable list used in setting up a dashboard software. As described above, a shared computing device may be configured to execute dashboard software (or proxy dashboard software) that links to services associated with numerous applications, devices, and users. However, users of the shared computing device may desire to have a customized dashboard front-end that only addresses certain applications installed on the shared computing device, or alternatively certain applications installed on nearby devices. For example, a Dad may want a family tablet device executing dashboard software to only provide notifications of his Facebook account and not his Twitter account. As another example, a daughter may desire a family tablet device executing dashboard software to receive notifications related to a networking app that is only installed on the daughter's iPhone. The method 1200 may be performed on a computing device to receive selection information that may configure the dashboard software executing on the shared computing device to link to services as selected by users. In various embodiments, other devices, such as personal devices utilizing dashboard software (e.g., a smartphone belonging to a member of a family, a tablet used by a doctor in a hospital, etc.), may also be configured to perform the operations of the method 1200.

In block 1202, the shared computing device may obtain with the dashboard software a list of devices, user accounts, account credentials, and/or applications relevant to services to which the shared computing device may link. In general, the obtained list may include the options for linking the dashboard software to retrieve account information, such as social networking message notifications. The obtained list may include devices that are known to have instances of the dashboard software installed, such as the personal devices of the members of a family using the shared computing device or nearby smartphones connected to the shared computing device via peer-to-peer communications. The obtained list may also include applications installed on the shared computing device and/or applications installed on other devices. For example, the list may indicate that the shared computing device has App Blue installed and that's Junior's smartphone has App Red installed. The list may also indicate the user accounts associated with the applications installed on the shared computing device and/or the applications installed on other devices. For example, the list may indicate that App Blue is installed on the shared computing device and that the shared computing device has App Blue user account credentials for Mom and Dad.

The shared computing device may obtain the list in various manners. For example, the shared computing device may use the dashboard software to broadcast ping messages, such as via Bluetooth LE wireless signals, to nearby devices also equipped with the dashboard software (or proxy dashboard software) and may obtain the list based on ping response messages. As another example, the list may be obtained by the shared computing device based on user inputs (e.g., users may provide the IP address, name, or other identifying addresses of devices). As yet another example, the shared computing device executing the dashboard software may obtain the list by retrieving data from a server. In particular, the shared computing device may use the dashboard software to transmit a request message to a server that stores configuration data indicating the identities, installed programs, associated user accounts, and other information of all devices utilizing dashboard software (or proxy dashboard software).

In block 1204, the shared computing device may present the obtained list to a user, such as by rendering a selection list on a touchscreen display. In other words, the shared computing device may present the user with options as to the available services to which the dashboard software may link. By presenting such a list, the shared computing device may enable users to tailor the devices, accounts, and services that are represented via dashboard front-end displays, as described above. In block 1206, the shared computing device may receive selection information based on detected user input. For example, the shared computing device may detect touch inputs in areas of the touchscreen display that are associated with particular items of the presented list, thereby representing a selection of those particular items.

In block 1208, the shared computing device may link the dashboard software to services associated with the received selection information. For example, when the selection information indicates that a user selected a personal device, the shared computing device executing the dashboard software may exchange peer-to-peer communications with the selected personal device to identify the applications installed on the selected personal device, as well as receive any related user account credentials, so that the shared computing device may link the dashboard software to the applications installed on the personal device. In optional block 1210, the shared computing device may upload configuration data to a server with the dashboard software. In particular, the shared computing device may upload or otherwise transmit user account credentials, applications installed on the shared computing device and/or other devices (e.g., personal devices), and any linkages to other devices (e.g., P2P connections, Bluetooth pairings/bindings, etc.), applications, or accounts. As described above, the server may be a central server that maintains configuration data for all devices executing dashboard software.

In block 204, the shared computing device may store with the dashboard software account credentials of users having accounts with the linked services. In an embodiment, the account credentials may be received by the shared computing device with the operations in block 1202. In block 206, the shared computing device may retrieve with the dashboard software user account information using the stored account credentials. In block 208, the shared computing device may display on a dashboard front-end the retrieved user account information.

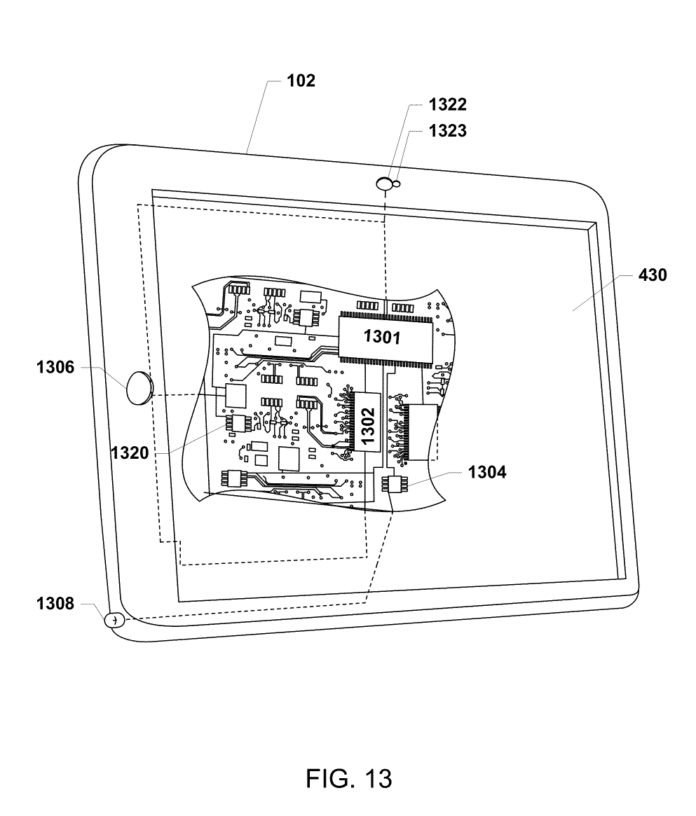

The various embodiments may be implemented in any of a variety of tablet devices, an example of which is illustrated in FIG. 13. For example, the tablet computing device 102 may include a processor 1301 coupled to internal memory 1302. The internal memory 1302 may be volatile or non-volatile memory, and may also be secure and/or encrypted memory, or unsecure and/or unencrypted memory, or any combination thereof. The processor 1301 may also be coupled to a touchscreen display 430, such as a resistive-sensing touch screen, capacitive-sensing touch screen infrared sensing touch screen, etc. The tablet computing device 102 may have one or more short-range radio signal transceivers 1304 (e.g., Peanut, Bluetooth®, Zigbee®, RF radio) and antennas 1308 for sending and receiving wireless signals as described herein. The transceivers 1304 and antennas 1308 may be used with the above-mentioned circuitry to implement the various wireless transmission protocol stacks and interfaces. The tablet computing device 102 may include a cellular network wireless modem chip 1320 that enables communication via a cellular network. The tablet computing device 102 may also include a physical button 1306 for receiving user inputs. The tablet computing device 102 may include a camera 1322 and a connected microphone 1323 configured to capture and store still images and video data with corresponding audio data.

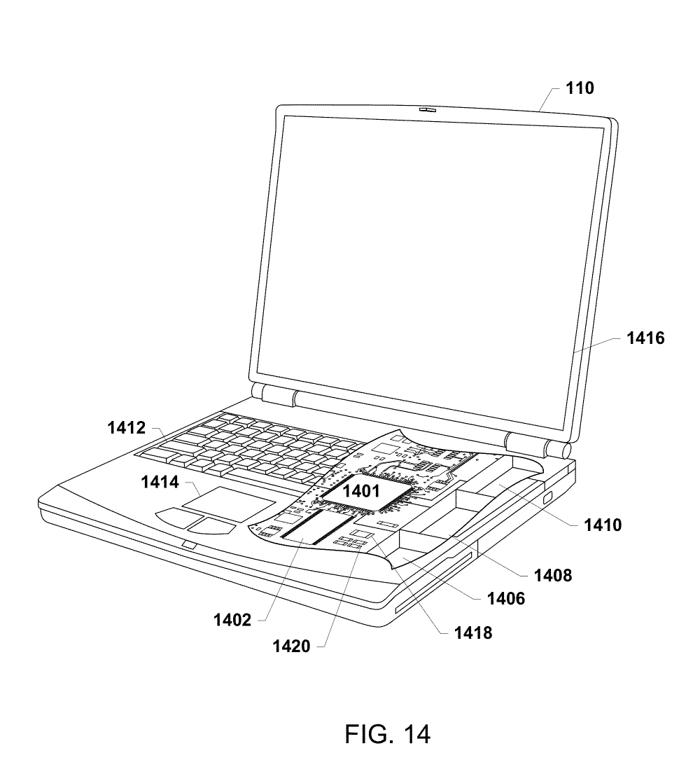

Various forms of computing devices (or mobile computing devices), including personal computers and laptop computers, may be used to implementing the various aspects. Such computing devices typically include the components illustrated in FIG. 14 which illustrates an example laptop computing device 110. Many laptop computers include a touch pad 1414 that serves as the computer's pointing device, and thus may receive drag, scroll, and flick gestures similar to those implemented on mobile computing devices equipped with a touch screen display and described above. Such a laptop computing device 110 generally includes a processor 1401 coupled to volatile internal memory 1402 and a large capacity nonvolatile memory, such as a disk drive 1406. The laptop computing device 110 may also include a compact disc (CD) and/or DVD drive 1408 coupled to the processor 1401. The laptop computing device 110 may also include a number of connector ports 1410 coupled to the processor 1401 for establishing data connections or receiving external memory devices, such as a network connection circuit for coupling the processor 1401 to a network. The laptop computing device 110 may have one or more short-range radio signal transceivers 1418 (e.g., Peanut®, Bluetooth®, Zigbee®, RF radio) and antennas 1420 for sending and receiving wireless signals. In a laptop or notebook configuration, the computer housing includes the touch pad 1414, the keyboard 1412, and the display 1416 all coupled to the processor 1401. Other configurations of the laptop mobile computing device may include a computer mouse or trackball coupled to the processor (e.g., via a USB input) as are well known, which may also be used in conjunction with the various aspects.

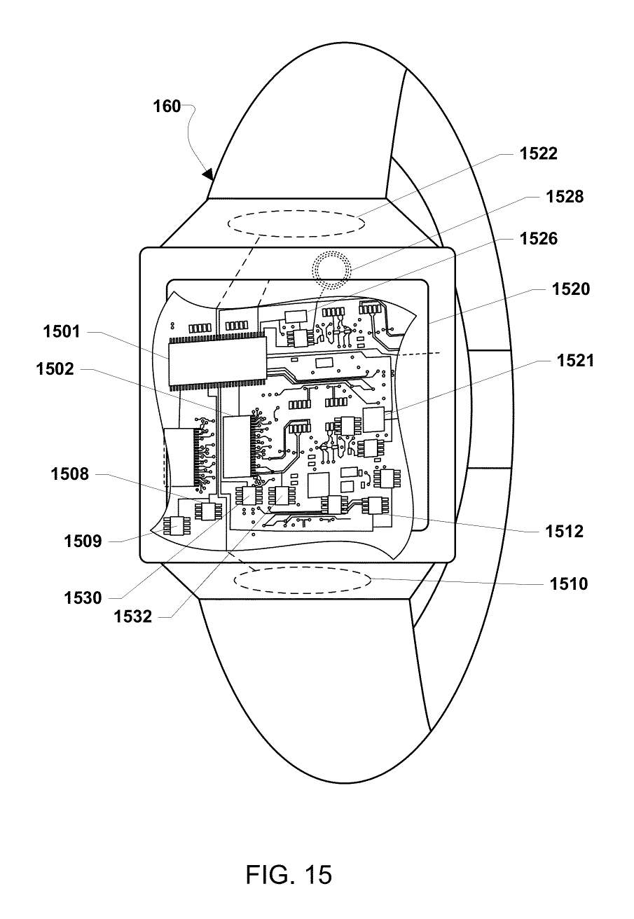

The various embodiments described above may be implemented within a variety of wireless wrist-mounted mobile computing devices, such as a wristwatch-type mobile computing device 160 as illustrated in FIG. 15. A wrist-mounted (or wristwatch-type) mobile computing device 160 may include a processor 1501 coupled to internal memory 1502. The internal memory 1502 may be volatile or non-volatile memory, and may also be secure and/or encrypted memory, or unsecure and/or unencrypted memory, or any combination thereof. The processor 1501 may also be coupled to a touch screen display 1520, such as a resistive-sensing touch screen, capacitive-sensing touch screen infrared sensing touch screen, or the like. Additionally, the wristwatch-type mobile computing device 160 may include a Peanut transceiver 1508, another short-range radio transceiver 1509 (e.g., Bluetooth®, Zigbee®, RF radio) and antennas 1521 for sending and receiving wireless signals as described herein. The transceivers 1508, 1509 and antennas 1521 may be used with the above-mentioned circuitry to implement the various wireless transmission protocol stacks/interfaces. The wristwatch-type mobile computing device 160 may also include physical buttons 1522 and 1510 for receiving user inputs. The wristwatch-type mobile computing device 160 may also include various motion sensors, such as a suite of accelerometers 1512, gyroscopes 1532, and an electronic compass 1530 coupled to the processor 1501. The wristwatch-type mobile computing device 160 may include a battery 1526 and a microphone 1528 to receive audio input, all of which may be coupled to the processor 1501.

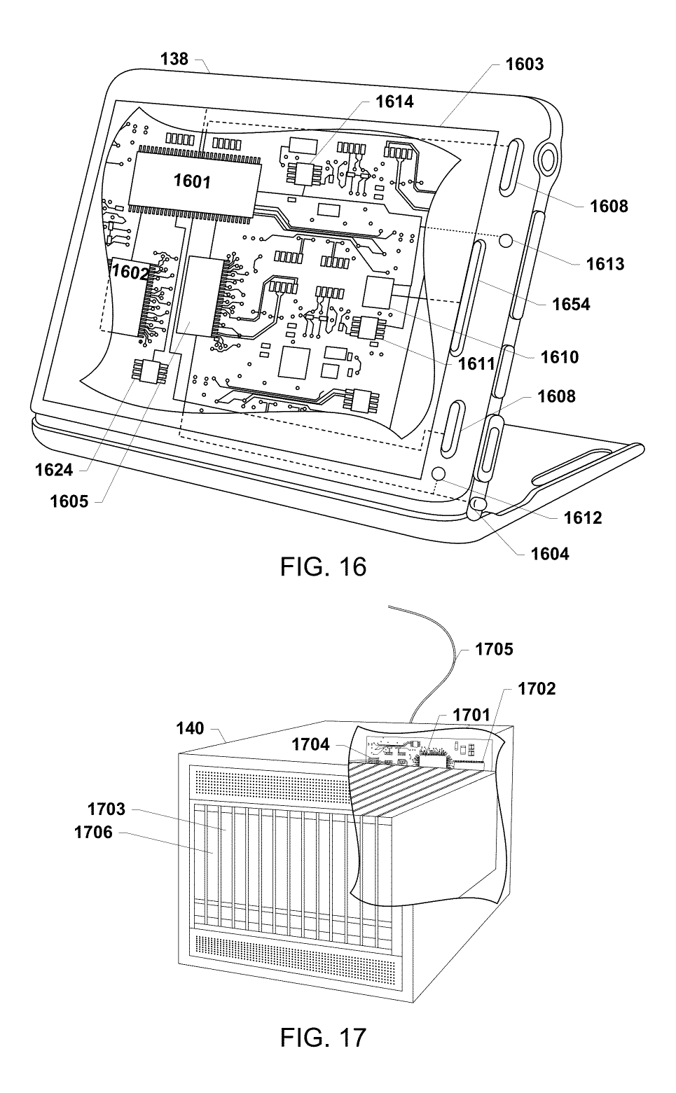

FIG. 16 is a system block diagram of a smartphone-type mobile computing device 138 suitable for use with various embodiments. The smartphone mobile computing device 138 may include a processor 1601 coupled to internal memory 1602, a display 1603, and to a speaker 1654. Additionally, the smartphone mobile computing device 138 may include an antenna 1604 for sending and receiving electromagnetic radiation that may be connected to a wireless data link and/or long-range wireless signal transceiver 1605, such as a cellular network or WiFi radio, coupled to the processor 1601 and capable of communicating over a wide area wireless communication network. Smartphone mobile computing devices 138 may include a separate short-range radio transceiver 1624 capable of communicating or pairing with other mobile computing devices. Smartphone mobile computing devices 138 typically may also include menu selection buttons or rocker switches 1608 for receiving user inputs. Additionally, the smartphone mobile computing device 138 may include an accelerometer 1610, a gyroscope 1611, and a GPS receiver chip 1614 coupled to the processor 1601. In an embodiment, the smartphone mobile computing device 138 may also include a microphone 1612 and a camera 1613 coupled to the processor 1601.

The various embodiments may be implemented on any of a variety of commercially available server devices, such as the server 140 illustrated in FIG. 17. Such a server 140 typically includes a processor 1701 coupled to volatile memory 1702 and a large capacity nonvolatile memory, such as a disk drive 1703. The server 140 may also include a floppy disc drive, compact disc (CD) or DVD disc drive 1706 coupled to the processor 1701. The server 140 may also include network access ports 1704 coupled to the processor 1701 for establishing data connections with a network 1705, such as a local area network coupled to other broadcast system computers and servers. The server processor 1701 may be configured with server-executable instructions to perform server operations of the embodiment methods described above.

The processors 1301, 1401, 1501, 1601, and 1701 may be any programmable microprocessor, microcomputer or multiple processor chip or chips that can be configured by software instructions (applications) to perform a variety of functions, including the functions of the various aspects described above. In the various devices, multiple processors may be provided, such as one processor dedicated to wireless communication functions and one processor dedicated to running other applications. Typically, software applications may be stored in the internal memory 1302, 1402, 1502, 1602, and 1702 before they are accessed and loaded into the processors 1301, 1401, 1501, 1601, and 1701. The processors 1301, 1401, 1501, 1601, and 1701 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1301, 1401, 1501, 1601, and 1701 including internal memory or removable memory plugged into the various devices and memory within the processors 1301, 1401, 1501, 1601, and 1701.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The operations of a method or algorithm disclosed herein may be embodied in a processor-executable software module that may be stored on a non-transitory processor-readable or computer-readable storage medium. Non-transitory processor-readable storage media may be any available media that may be accessed by a computer or processor. By way of example, and not limitation, non-transitory computer-readable and processor-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable and processor-readable media. Additionally, the operations of a method or algorithm may reside as one or any combination or set of codes and/or instructions on a tangible, non-transitory machine readable medium and/or computer-readable medium that may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for accessing applications related to a computing device shared by two or more users, comprising:
linking a service to dashboard software, wherein the service is associated with an application installed on at least one of the shared computing device and a second device associated with one of the two or more users;
storing with the dashboard software account credentials for the two or more users having accounts with the service;
retrieving with the dashboard software using the stored account credentials user account information related to the service for the two or more users, wherein the user account information includes at least one of account notifications, messages, and updates; and
displaying on a dashboard front-end an indication based on the retrieved user account information.

2. The method of claim 1, wherein retrieving with the dashboard software using the stored account credentials user account information related to the service for the two or more users comprises:
retrieving with the dashboard software using the stored account credentials user account information related to the service for the two or more users via background processes.

3. The method of claim 2, wherein retrieving with the dashboard software using the stored account credentials user account information related to the service for the two or more users via background processes comprises retrieving the user account information related to the service for the two or more users by exchanging communications using the stored account credentials with an applications server associated with the service.

4. The method of claim 2, wherein retrieving with the dashboard software using the stored account credentials user account information related to the service for the two or more users via background processes comprises:
iteratively logging into the application associated with the service using the stored account credentials of each user;
retrieving the user account information related to the service for each of the two or more users; and
storing the retrieved user account information.

5. The method of claim 1, further comprising launching with the dashboard software the application based on the stored account credentials.

6. The method of claim 5, wherein the dashboard software is configured to launch the application in response to receiving one of a secret phrase, a password, or a security key associated with the account credentials.

7. The method of claim 1, wherein the dashboard software is executing on both the shared computing device and the second device, the method further comprising connecting the dashboard software executing on the shared computing device with the dashboard software executing on the second device with one of a peer-to-peer connection and a WAN connection.

8. The method of claim 7, further comprising transmitting via the connected dashboard software the retrieved user account information to the second device for display on the second device.

9. The method of claim 1, wherein the second device is one of a smartphone mobile computing device and a wrist-mounted mobile computing device.

10. The method of claim 7, wherein retrieving with the dashboard software using the stored account credentials user account information related to the service for the two or more users comprises:
retrieving via the connected dashboard software the user account information associated with one of the two or more users.

11. The method of claim 7, wherein the application is installed on the second device, the method further comprising:
obtaining with the dashboard software information indicating the application is installed on the second device; and
obtaining with dashboard software account credentials of a user having an account with the service related to the application installed on the second device.

12. The method of claim 1, further comprising uploading configuration data to a server by the dashboard software, wherein the configuration data includes at least one of applications installed on the shared computing device, applications installed on the second device, identifying information, linkages, and account credentials.

13. The method of claim 1, further comprising obtaining with the dashboard software a list that includes at least one of devices, user accounts, and applications that may be used to link to the dashboard software,
wherein linking a service to the dashboard software comprises linking the dashboard software to the service based on a selection input corresponding to the obtained list.

14. The method of claim 13, wherein obtaining with the dashboard software a list that includes at least one of devices, user accounts, user account credentials, and applications that may be used to link to the dashboard software comprises obtaining with the dashboard software the list from a server, wherein the list includes data uploaded to the server by the dashboard software.

15. The method of claim 1, wherein the account credentials for the two or more users are provided by respective users using the dashboard software.

16. A computing device, comprising:
means for linking a service to a dashboard software executing on the computing device, wherein the service is associated with an application installed on at least one of the computing device and a second device associated with one of two or more users;
means for storing with the dashboard software account credentials for the two or more users having accounts with the service;
means for retrieving with the dashboard software using the stored account credentials user account information related to the service for the two or more users, wherein the user account information includes at least one of account notifications, messages, and updates; and
means for displaying on a dashboard front-end an indication based on the retrieved user account information.

17. The computing device of claim 16, wherein means for retrieving with the dashboard software using the stored account credentials user account information related to the service for the two or more users comprises:
means for retrieving with the dashboard software using the stored account credentials user account information related to the service for the two or more users via background processes.

18. The computing device of claim 17, wherein means for retrieving with the dashboard software using the stored account credentials user account information related to the service for the two or more users via background processes comprises means for retrieving the user account information related to the service for the two or more users by exchanging communications using the stored account credentials with an applications server associated with the service.

19. The computing device of claim 17, wherein means for retrieving with the dashboard software using the stored account credentials user account information related to the service for the two or more users via background processes comprises:
means for iteratively logging into the application associated with the service using the stored account credentials of each user;
means for retrieving the user account information related to the service for each of the two or more users; and
means for storing the retrieved user account information.

20. The computing device of claim 16, further comprising means for launching with the dashboard software the application based on the stored account credentials.

21. The computing device of claim 20, wherein the dashboard software is configured to launch the application in response to receiving one of a secret phrase, a password, or a security key associated with the account credentials.

22. The computing device of claim 16, wherein the dashboard software is executing on both the computing device and the second device, the computing device further comprising means for connecting the dashboard software executing on the computing device with the dashboard software executing on the second device with one of a peer-to-peer connection and a WAN connection.

23. The computing device of claim 22, further comprising means for transmitting via the connected dashboard software the retrieved user account information to the second device for display on the second device.

24. The computing device of claim 16, wherein the second device is one of a smartphone mobile computing device and a wrist-mounted mobile computing device.

25. The computing device of claim 22, wherein means for retrieving with the dashboard software using the stored account credentials user account information related to the service for the two or more users comprises:
means for retrieving via the connected dashboard software the user account information associated with one of the two or more users.

26. The computing device of claim 22, wherein the application is installed on the second device, the computing device further comprising:
means for obtaining with the dashboard software information indicating the application is installed on the second device; and
means for obtaining with dashboard software account credentials of a user having an account with the service related to the application installed on the second device.

27. The computing device of claim 16, further comprising means for uploading configuration data to a server by the dashboard software, wherein the configuration data includes at least one of applications installed on the computing device, applications installed on the second device, identifying information, linkages, and account credentials.

28. The computing device of claim 16, further comprising means for obtaining with the dashboard software a list that includes at least one of devices, user accounts, and applications that may be used to link to the dashboard software, and
wherein means for linking a service to the dashboard software comprises linking the dashboard software to the service based on a selection input corresponding to the obtained list.

29. The computing device of claim 28, wherein means for obtaining with the dashboard software a list that includes at least one of devices, user accounts, user account credentials, and applications that may be used to link to the dashboard software comprises means for obtaining with the dashboard software the list from a server, wherein the list includes data uploaded to the server by the dashboard software.

30. The computing device of claim 16, wherein the account credentials for the two or more users are provided by respective users using the dashboard software.

31. A computing device, comprising:
a memory; and
a processor coupled to the memory, wherein the processor is configured with processor-executable instructions to perform operations comprising:
linking a service to a dashboard software, wherein the service is associated with an application installed on at least one of the computing device and a second device associated with one of two or more users;
storing with the dashboard software account credentials for the two or more users having accounts with the service;
retrieving with the dashboard software using the stored account credentials user account information related to the service for the two or more users, wherein the user account information includes at least one of account notifications, messages, and updates; and
displaying on a dashboard front-end an indication based on the retrieved user account information.

32. The computing device of claim 31, wherein the processor is configured with processor-executable instructions to perform operations such that retrieving with the dashboard software using the stored account credentials user account information related to the service for the two or more users comprises:
retrieving with the dashboard software using the stored account credentials user account information related to the service for the two or more users via background processes.

33. The computing device of claim 32, wherein the processor is configured with processor-executable instructions to perform operations such that retrieving with the dashboard software using the stored account credentials user account information related to the service for the two or more users via background processes comprises retrieving the user account information related to the service for the two or more users by exchanging communications using the stored account credentials with an applications server associated with the service.

34. The computing device of claim 32, wherein the processor is configured with processor-executable instructions to perform operations such that retrieving with the dashboard software using the stored account credentials user account information related to the service for the two or more users via background processes comprises:
iteratively logging into the application associated with the service using the stored account credentials of each user;
retrieving the user account information related to the service for each of the two or more users; and
storing the retrieved user account information.

35. The computing device of claim 31, wherein the processor is configured with processor-executable instructions to perform operations further comprising launching with the dashboard software the application based on the stored account credentials.

36. The computing device of claim 35, wherein the dashboard software is configured to launch the application in response to receiving one of a secret phrase, a password, or a security key associated with the account credentials.

37. The computing device of claim 31, wherein the dashboard software is executing on both the computing device and the second device, and
wherein the processor is configured with processor-executable instructions to perform operations further comprising connecting the dashboard software executing on the computing device with the dashboard software executing on the second device with one of a peer-to-peer connection or a WAN connection.

38. The computing device of claim 37, wherein the processor is configured with processor-executable instructions to perform operations further comprising transmitting via the connected dashboard software the retrieved user account information to the second device for display on the second device.

39. The computing device of claim 31, wherein the second device is one of a smartphone mobile computing device and a wrist-mounted mobile computing device.

40. The computing device of claim 37, wherein the processor is configured with processor-executable instructions to perform operations such that retrieving with the dashboard software using the stored account credentials user account information related to the service for the two or more users comprises:
retrieving via the connected dashboard software the user account information associated with one of the two or more users.

41. The computing device of claim 37, wherein the application is installed on the second device, and
wherein the processor is configured with processor-executable instructions to perform operations the computing device further comprising:
obtaining with the dashboard software information indicating the application is installed on the second device; and
obtaining with dashboard software account credentials of a user having an account with the service related to the application installed on the second device.

42. The computing device of claim 31, wherein the processor is configured with processor-executable instructions to perform operations further comprising uploading configuration data to a server by the dashboard software, wherein the configuration data includes at least one of applications installed on the computing device, applications installed on the second device, identifying information, linkages, and account credentials.

43. The computing device of claim 31, wherein the processor is configured with processor-executable instructions to perform operations further comprising obtaining with the dashboard software a list that includes at least one of devices, user accounts, and applications that may be used to link to the dashboard software, and
wherein the processor is configured with processor-executable instructions to perform operations such that linking a service to the dashboard software comprises linking the dashboard software to the service based on a selection input corresponding to the obtained list.

44. The computing device of claim 43, wherein the processor is configured with processor-executable instructions to perform operations such that obtaining with the dashboard software a list that includes at least one of devices, user accounts, user account credentials, and applications that may be used to link to the dashboard software comprises obtaining with the dashboard software the list from a server, wherein the list includes data uploaded to the server by the dashboard software.

45. The computing device of claim 31, wherein the account credentials for the two or more users are provided by respective users using the dashboard software.

46. A non-transitory processor-readable storage medium having stored thereon processor-executable software instructions configured to cause a processor to perform operations for accessing applications related to a computing device shared by two or more users, the operations comprising:
linking a service to a dashboard software, wherein the service is associated with an application installed on at least one of the computing device and a second device associated with one of the two or more users;
storing with the dashboard software account credentials for the two or more users having accounts with the service;
retrieving with the dashboard software using the stored account credentials user account information related to the service for the two or more users, wherein the user account information includes at least one of account notifications, messages, and updates; and
displaying on a dashboard front-end an indication based on the retrieved user account information.

47. The non-transitory processor-readable storage medium of claim 46, wherein the stored processor-executable software instructions are configured to cause the processor to perform operations such that retrieving with the dashboard software using the stored account credentials user account information related to the service for the two or more users comprises:
retrieving with the dashboard software using the stored account credentials user account information related to the service for the two or more users via background processes.

48. The non-transitory processor-readable storage medium of claim 47, wherein the stored processor-executable software instructions are configured to cause the processor to perform operations such that retrieving with the dashboard software using the stored account credentials user account information related to the service for the two or more users via background processes comprises retrieving the user account information related to the service for the two or more users by exchanging communications using the stored account credentials with an applications server associated with the service.

49. The non-transitory processor-readable storage medium of claim 47, wherein the stored processor-executable software instructions are configured to cause the processor to perform operations such that retrieving with the dashboard software using the stored account credentials user account information related to the service for the two or more users via background processes comprises:
iteratively logging into the application associated with the service using the stored account credentials of each user;
retrieving the user account information related to the service for each of the two or more users; and
storing the retrieved user account information.

50. The non-transitory processor-readable storage medium of claim 46, wherein the stored processor-executable software instructions are configured to cause the processor to perform operations further comprising launching with the dashboard software the application based on the stored account credentials.

51. The non-transitory processor-readable storage medium of claim 50, wherein the dashboard software is configured to launch the application in response to receiving one of a secret phrase, a password, or a security key associated with the account credentials.

52. The non-transitory processor-readable storage medium of claim 46, wherein the dashboard software is executing on both the computing device and the second device, and
wherein the stored processor-executable software instructions are configured to cause the processor to perform operations further comprising connecting the dashboard software executing on the computing device with the dashboard software executing on the second device with one of a peer-to-peer connection or a WAN connection.

53. The non-transitory processor-readable storage medium of claim 52, wherein the stored processor-executable software instructions are configured to cause the processor to perform operations further comprising transmitting via the connected dashboard software the retrieved user account information to the second device for display on the second device.

54. The non-transitory processor-readable storage medium of claim 46, wherein the second device is one of a smartphone mobile computing device and a wrist-mounted mobile computing device.

55. The non-transitory processor-readable storage medium of claim 52, wherein the stored processor-executable software instructions are configured to cause the processor to perform operations such that retrieving with the dashboard software using the stored account credentials user account information related to the service for the two or more users comprises:
retrieving via the connected dashboard software the user account information associated with one of the two or more users.

56. The non-transitory processor-readable storage medium of claim 52, wherein the application is installed on the second device, and
wherein the stored processor-executable software instructions are configured to cause the processor to perform operations the computing device further comprising:
obtaining with the dashboard software information indicating the application is installed on the second device; and
obtaining with dashboard software account credentials of a user having an account with the service related to the application installed on the second device.

57. The non-transitory processor-readable storage medium of claim 46, wherein the stored processor-executable software instructions are configured to cause the processor to perform operations further comprising uploading configuration data to a server by the dashboard software, wherein the configuration data includes at least one of applications installed on the computing device, applications installed on the second device, identifying information, linkages, and account credentials.

58. The non-transitory processor-readable storage medium of claim 46, wherein the stored processor-executable software instructions are configured to cause the processor to perform operations further comprising obtaining with the dashboard software a list that includes at least one of devices, user accounts, and applications that may be used to link to the dashboard software, and
wherein the stored processor-executable software instructions are configured to cause the processor to perform operations such that linking a service to the dashboard software comprises linking the dashboard software to the service based on a selection input corresponding to the obtained list.

59. The non-transitory processor-readable storage medium of claim 58, wherein the stored processor-executable software instructions are configured to cause the processor to perform operations such that obtaining with the dashboard software a list that includes at least one of devices, user accounts, user account credentials, and applications that may be used to link to the dashboard software comprises obtaining with the dashboard software the list from a server, wherein the list includes data uploaded to the server by the dashboard software.

60. The non-transitory processor-readable storage medium of claim 46, wherein the account credentials for the two or more users are provided by respective users using the dashboard software.

61. A system, comprising:
a computing device shared by two or more users; and
a second device associated with one of the two or more users,
wherein the shared computing device comprises:
a first memory;
a first transceiver configured to communicate with the second device; and
a first processor coupled to the first memory and the first transceiver, and configured with processor-executable instructions to perform operations comprising:
executing a first dashboard software on the shared computing device that is capable of connecting with a second dashboard software executing on the second device;
linking a service to the first dashboard software, wherein the service is associated with an application installed on at least one of the shared computing device and the second device;
storing with the first dashboard software account credentials for the two or more users having accounts with the service;
retrieving with the first dashboard software using the stored account credentials user account information related to the service for the two or more users, wherein the user account information includes at least one of account notifications, messages, and updates; and
displaying on a dashboard front-end an indication based on the retrieved user account information, and
wherein the second device comprises:
a second memory;
a second transceiver configured to communicate with the shared computing device; and
a second processor coupled to the second memory and the second transceiver, and configured with processor-executable instructions to perform operations comprising:
executing the second dashboard software on the second device that is capable of connecting with the first dashboard software executing on the shared computing device.

62. The system of claim 61, wherein the second device is one of a smartphone mobile computing device and a wrist-mounted mobile computing device.

63. The system of claim 61, wherein the shared computing device is configured with processor-executable instructions to perform operations such that retrieving with the first dashboard software using the stored account credentials user account information related to the service for the two or more users comprises retrieving with the first dashboard software using the stored account credentials user account information related to the service for the two or more users via background processes.

64. The system of claim 63, wherein the shared computing device is configured with processor-executable instructions to perform operations such that retrieving with the first dashboard software using the stored account credentials user account information related to the service for the two or more users via background processes comprises retrieving the user account information related to the service for the two or more users by exchanging communications using the stored account credentials with an applications server associated with the service.

65. The system of claim 63, wherein the shared computing device is configured with processor-executable instructions to perform operations such that retrieving with the first dashboard software using the stored account credentials user account information related to the service for the two or more users via background processes comprises:
iteratively logging into the application associated with the service using the stored account credentials of each user;
retrieving the user account information related to the service for each of the two or more users; and
storing the retrieved user account information.

66. The system of claim 61, wherein the shared computing device is configured with processor-executable instructions to perform operations further comprising launching with the first dashboard software the application based on the stored account credentials, wherein the application is installed on the shared computing device.

67. The system of claim 66, wherein the first dashboard software is configured to launch the application in response to receiving one of a secret phrase, a password, or a security key associated with the account credentials.

68. The system of claim 61, wherein the shared computing device is configured with processor-executable instructions to perform operations further comprising connecting the first dashboard software executing on the shared computing device with the second dashboard software executing on the second device.

69. The system of claim 68, wherein the first dashboard software and the second dashboard software are connected using one of a peer-to-peer connection or a WAN connection.

70. The system of claim 68, wherein the shared computing device is configured with processor-executable instructions to perform operations further comprising
transmitting via the first dashboard software the retrieved user account information to the second device, and
wherein the second device is configured with processor-executable instructions to perform operations further comprising:
receiving via the second dashboard software the user account information transmitted by the shared computing device; and
displaying the received user account information on the second device.

71. The system of claim 68, wherein the application is installed on the second device, and
wherein the shared computing device is configured with processor-executable instructions to perform operations further comprising:
obtaining with the first dashboard software information indicating the application is installed on the second device; and
obtaining with the first dashboard software account credentials of a user having an account with the service related to the application installed on the second device.

72. The system of claim 61, further comprising:
a server, and
wherein the shared computing device is configured with processor-executable instructions to perform operations further comprising uploading configuration data to the server by the first dashboard software, wherein the configuration data includes at least one of applications installed on the shared computing device, applications installed on the second device, identifying information, linkages, and account credentials, and
wherein the server is configured with server-executable instructions to perform operations comprising storing the configuration data.

73. The system of claim 61, wherein the shared computing device is configured with processor-executable instructions to perform operations further comprising obtaining with the first dashboard software a list that includes at least one of devices, user accounts, and applications that may be used to link to the first dashboard software, and
wherein the shared computing device is configured with processor-executable instructions to perform operations such that linking a service to the first dashboard software comprises linking the first dashboard software to the service based on a selection input corresponding to the obtained list.

74. The system of claim 73, further comprising a server,
wherein the shared computing device is configured with processor-executable instructions to perform operations such that obtaining with the first dashboard software a list that includes at least one of devices, user accounts, user account credentials, and applications that may be used to link to the first dashboard software comprises obtaining with the first dashboard software the list from the server, wherein the list includes data uploaded to the server by one of the first dashboard software or the second dashboard software, and
wherein the server is configured with server-executable instructions to perform operations comprising transmitting the list to at least one of the shared computing device and the second device.
